(19) United States
(12) Patent Application Publication
(10) Pub. No.: US 2024/0422453 A1
(43) Pub. Date: Dec. 19, 2024

(54) PHYSICAL QUANTITY DETECTING DEVICE AND IMAGING DEVICE

(71) Applicant: SONY SEMICONDUCTOR SOLUTIONS CORPORATION, KANAGAWA (JP)

(72) Inventors: MASAKI SAKAKIBARA, TOKYO (JP); SHIN KITANO, KANAGAWA (JP)

(21) Appl. No.: 18/703,732

(22) PCT Filed: Oct. 20, 2022
(86) PCT No.: PCT/JP2022/039081

§ 371 Date: Apr. 23, 2024

(30) Foreign Application Priority Data
Nov. 1, 2021 (JP) 2021-178947

(51) Int. Cl. H04N 25/772; H04N 25/703; H04N 25/76; H04N 25/771

(52) U.S. Cl. CPC H04N 25/772; H04N 25/703; H04N 25/771; H04N 25/7795

(57) ABSTRACT

[Object] To prevent a defect that pixel data transfer is not completed in time. [Solving Means] A physical quantity detection device includes at least two pixel groups that each detect a physical quantity, a storage section that stores data corresponding to the physical quantity detected by a pixel in each of the pixel groups, and a storage control section that performs control to cause the storage section to store the data, and controls, for each of the pixel groups, whether or not to update the data stored in the storage section.

### TECHNICAL FIELD

The present disclosure relates to a physical quantity detecting device and an imaging device.

### BACKGROUND ART

Such a pixel ADC type imaging device has been known that includes an AD converter (hereinafter, ADC) for performing analog-digital conversion (hereinafter, AD conversion) of a pixel signal having undergone photoelectric conversion at each pixel (see PTL 1). In such a common pixel ADC type imaging device, an ADC and a storage section storing pixel data having undergone AD conversion are provided in each pixel.

### CITATION LIST

### Patent Literature

### [PTL 1]

PCT Patent Publication No. WO16/136448

### SUMMARY

### Technical Problem

In a pixel ADC type imaging device, pixel data having undergone AD conversion at each pixel is transferred to an output section. It is necessary to transfer the pixel data within a vertical synchronization period or within one frame period. However, in a case where the number of pixels is large or the frame rate is high, AD-converted pixel data is not completely transferred to the output section within one frame period. This may cause a defect such as degradation of image quality of a captured image.

In recent years, pixels in a pixel array section are used for another purpose (for a purpose of detecting various physical quantities, for example) in addition to the purpose of capturing images, in some cases. In addition, even if the pixels are used for capturing images, a frame rate and a resolution that are required to capture a video differ from those required to capture a static image. When image data transfer is not completed within one frame period, a defect that, for example, a physical quantity is not correctly detected occurs.

To this end, the present disclosure provides a physical quantity detecting device and an imaging device with which a defect that pixel data transfer is not completed in time can be prevented.

### Solution to Problem

In order to solve the above problem, the present disclosure provides a physical quantity detecting device including at least two pixel groups that each detect a physical quantity, a storage section that stores data corresponding to the physical quantity detected by a pixel in each of the pixel groups, and a storage control section that performs control to cause the storage section to store the data, and further, controls, for each of the pixel groups, whether or not to update the data stored in the storage section.

The storage section may be an analog memory or a digital memory.

The physical quantity detecting device may further include an AD converter that includes the storage section, and that converts a physical quantity signal detected for each pixel in each of the pixel groups, to a digital signal by comparing the physical quantity signal with a reference signal.

The physical quantity detecting device may further includes a clock-time code generation section that generates a clock-time code that changes with time, and a reference signal generation section that generates the reference signal the voltage level of which changes with time, and the storage section may store the clock-time code corresponding to a timing at which the clock-time code matches the reference signal.

All pixels in the two pixel groups may detect the physical quantities at the same timing every prescribed period, and for a pixel group, of the at least two pixel groups, in which output of data in the storage section of each pixel in the pixel group is not completed in the prescribed period, the storage control section may retain the data stored in the storage section in a following prescribed period without updating the data.

The prescribed period may be a cycle of a vertical synchronization signal.

The at least two pixel groups may have different pixel characteristics.

The pixel characteristic may include a pixel sensitivity and/or a saturation quantity of storable physical quantity signals.

The pixel characteristic may include at least one of a phase difference, brightness information, gradation information, color information, event information, environment information, biological information, and sonic information.

The pixel characteristic may include a resolution of an AD converter that is provided for each pixel in the at least two pixel groups.

The pixel characteristic may include a storage capacity of the storage section.

The at least two pixel groups may have different signal detection periods.

The signal detection period may include an exposure time and/or a signal reading time.

The physical quantity detecting device may further include an interpolation processing section that interpolates a physical quantity of a pixel that is not included in the pixel group, with a physical quantity of a pixel that is located therearound and belongs to the pixel group.

The physical quantity detecting device may further include a pixel array section including a plurality of pixels that is divided into the at least two pixel groups, a plurality of control wires that controls reading of all pixels in the pixel array section, and a contact that connects each pixel in the pixel array section to the corresponding control wire according to which pixel group the pixel belongs to.

The plurality of control wires may be arranged in regions of all pixels in the pixel array section, and each pixel in the pixel array section may be connected to any one of the control wires via the contact.

The physical quantity may include at least one of at least one of a light intensity, a sound pressure of a sound wave, and a biological information amount.

The physical quantity may include a light intensity, and the at least two pixel groups may include at least one of a region for capturing a still picture image, a region for capturing a video, and a region for detecting an image plane phase difference.

The present disclosure provides an imaging device including a pixel array section that includes a plurality of pixels that is divided into at least two pixel groups, an AD converter that is disposed in each of the pixels and performs analog-digital conversion of a pixel signal, a clock-time code generation section that generates a clock-time code that changes with time, a reference signal generation section that generates a reference signal a voltage level of which changes with time, a signal processing section that performs signal processing on pixel data outputted from the AD converter of each of the pixels, the AD converter including a storage section that stores the clock-time code corresponding to the pixel signal by comparing the pixel signal with the reference signal, and a storage control section that performs control to cause the storage section to store the clock-time code, and controls, for each of the pixel groups, whether or not to update the clock-time code stored in the storage section.

For a pixel group in which output of data of all pixels is not completed in a vertical synchronization period, the storage control section may retain the clock-time code stored in the corresponding storage section in a following vertical synchronization period without updating the stored clock-time code.

### BRIEF DESCRIPTION OF DRAWINGS

FIG. 1 is a schematic configuration diagram of a solid state imaging device according to the present disclosure.

FIG. 2 is a block diagram depicting a detailed configuration example of a pixel.

FIG. 3 is a block diagram depicting a detailed configuration example of a comparison circuit.

FIG. 4 is a chart indicating transitions of respective signals during operation of the comparison circuit.

FIG. 5 is a diagram for explaining a detailed configuration of a pixel circuit.

FIG. 6 is a timing chart for explaining operation of a pixel.

FIG. 7 is a circuit diagram depicting one example of an inner structure of a clock-time code transfer section and a data storage section.

FIG. 8 is a circuit diagram depicting an inner structure of a P-phase bit storage section and a D-phase bit storage section.

FIG. 9 is a circuit diagram depicting an example in which a latch circuit is formed of an analog memory.

FIG. 10A is a diagram depicting one example of pixel groups in a pixel array section.

FIG. 10B is a diagram depicting one modification of FIG. 9A.

FIG. 11 is a diagram in which a pixel data reading order of pixels in a first pixel group is indicated by arrows.

FIG. 12 is a diagram in which a pixel data reading order in a second group is indicated by arrows.

FIG. 13A is a diagram in which the pixel data reading order in a third pixel group is indicated by arrows.

FIG. 13B is a diagram depicting a continuation of FIG. 13A.

FIG. 13C is a diagram depicting a continuation of FIG. 13B.

FIG. 13D is a diagram depicting a continuation of FIG. 13C.

FIG. 14 is a timing chart of an imaging device 1 according to the present embodiment.

FIG. 15A is a diagram depicting a representative specific example of an interpolation process.

FIG. 15B is a diagram depicting a representative specific example of an interpolation process.

FIG. 15C is a diagram depicting a representative specific example of an interpolation process.

FIG. 15D is a diagram depicting a representative specific example of an interpolation process.

FIG. 16 is a diagram depicting one example of forming the imaging device by layering a pixel substrate and a logic substrate.

FIG. 17 is a block diagram depicting an example of schematic configuration of a vehicle control system.

FIG. 18 is a diagram of assistance in explaining an example of installation positions of an outside-vehicle information detecting section and an imaging section.

### DESCRIPTION OF EMBODIMENTS

Hereinafter, embodiments of a physical quantity detecting device and an imaging device will be explained with reference to the drawings. The main components of the physical quantity detecting device and the imaging device will be mainly explained below, but any other component or function which is not depicted or explained herein can be included in the physical quantity detecting device and the imaging device. The following explanation is not intended to exclude such a component or function which is not depicted or explained herein.

Hereinafter, the imaging device will be mainly explained as one example of the physical quantity detecting device, but the physical quantity detecting device according to the present disclosure is not limited to imaging devices, as will be discussed later.

### <Schematic Configuration Example of Imaging Device>

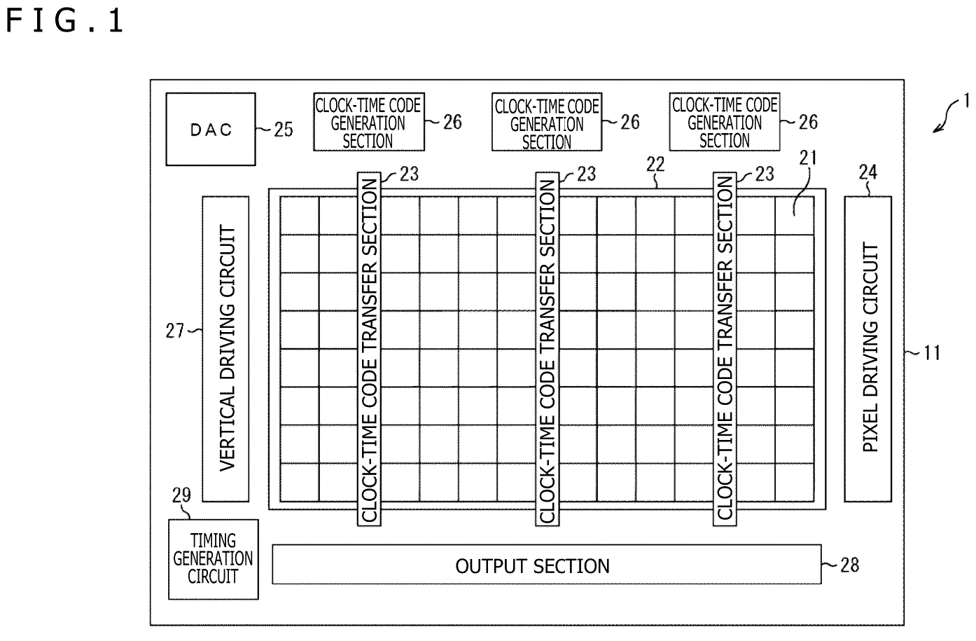

FIG. 1 depicts a schematic configuration of an imaging device 1 according to the present disclosure. The imaging device 1 which is formed on a semiconductor substrate will be mainly explained below. The imaging device 1 of this type may be referred to as a solid state imaging device 1, but will be simply referred to as the imaging device 1 in the following explanation.

The imaging device 1 in FIG. 1 includes a pixel array section 22 having pixels 21 arranged in a two-dimensional array on a semiconductor substrate 11 in which, for example, silicon (Si) is used as a semiconductor. The pixel array section 22 includes a clock-time code transfer section 23 that transfers a clock-time code generated by a clock-time code generation section 26 to each of the pixels 21. Further, a pixel driving circuit 24, a DAC (D/A converter, reference signal generation section) 25, the clock-time code generation section 26, a vertical driving circuit 27, an output section 28, and a timing generation circuit 29 are formed around the pixel array section 22 on the semiconductor substrate 11.

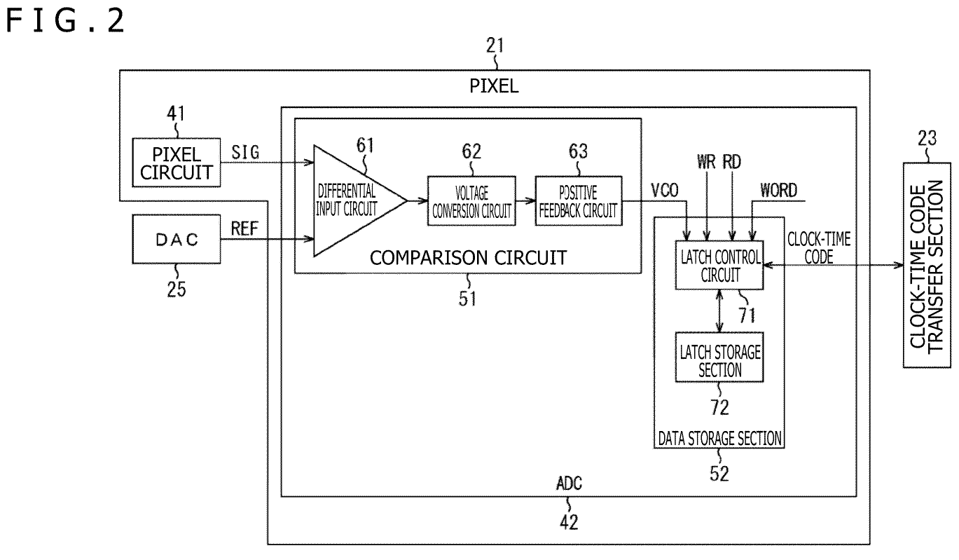

FIG. 2 is a block diagram depicting a configuration of each of the pixels 21 that are arranged in a two-dimensional array in the pixel array section 22. Each of the pixels 21 includes a pixel circuit 41 and an ADC 42, as depicted in FIG. 2. Each of the pixels 21 generates an electric charge signal according to the quantity of light received by an inner light receiving element (e.g. photodiode) of the pixel, converts the electric charge signal to a digital pixel signal, and outputs the digital pixel signal.

The pixel driving circuit 24 in FIG. 1 drives the pixel circuit 41 (FIG. 2) in each pixel 21. The DAC 25 generates a reference signal (reference voltage signal) REF which is a slope signal the level (voltage) of which monotonously decreases with the elapsed time, and supplies the reference signal REF to each of the pixels 21. The clock-time code generation section 26 generates a clock-time code which is used for conversion (AD conversion) of an analog pixel signal SIG to a digital pixel signal at each of the pixels 21, and supplies the corresponding clock-time code transfer section 23. A plurality of the clock-time code generation sections 26 is disposed in the pixel array section 22. The clock-time code transfer sections 23 that are as many as the clock-time code generation sections 26, are disposed in the pixel array section 22. That is, the clock-time code generation sections 26 and the clock-time code transfer sections 23 that transfer clock-time codes generated by the respective clock-time code generation sections 26, are in one-to-one relation.

The vertical driving circuit 27 performs control to output digital pixel signals generated in the pixels 21, in a prescribed order, to the output section 28 through the clock-time code transfer sections 23. Through the output section 28, the digital pixel signals outputted from the pixels 21 are outputted to the outside of the imaging device 1. The output section 28 performs a prescribed digital signal process such as a black level correction process of correcting a black level, a CDS (correlated double sampling) process, etc., if needed, and then, outputs the processed signals to the outside. Therefore, the output section 28 has a function of conducting a computation process and signal processing.

The timing generation circuit 29 includes a timing generator that generates timing signals, and supplies the generated timing signals to the pixel driving circuit 24, the DAC 25, the vertical driving circuit 27, etc.

The imaging device 1 has the above-mentioned configuration. It is to be noted that, in FIG. 1, all the circuits constituting the imaging device 1 are formed on one semiconductor substrate 11, but the circuits constituting the imaging device 1 may be distributedly disposed over a plurality of the semiconductor substrates 11, as will be described later.

### <Detailed Configuration Example of Pixel>

Each pixel 21 includes the pixel circuit 41 and the ADC (AD converter) 42, as depicted in FIG. 2. Therefore, the imaging device 1 according to the present embodiment is a pixel ADC type in which pixels include the respective ADCs 42.

The pixel circuit 41 outputs, as an analog pixel signal SIG, an electric charge signal according to the quantity of received light, to the ADC 42. The ADC 42 converts the analog pixel signal SIG supplied from the pixel circuit 41, to a digital pixel signal. The ADC 42 includes a comparison circuit 51 and a data storage section 52.

The comparison circuit 51 compares a reference signal REF supplied from the DAC 25 with the pixel signal SIG, and outputs an output signal VCO as a comparison result signal that indicates a result of the comparison. The comparison circuit 51 inverts the polarity of the output signal VCO when (the voltage of) the reference signal REF becomes equal to (the voltage of) the pixel signal SIG.

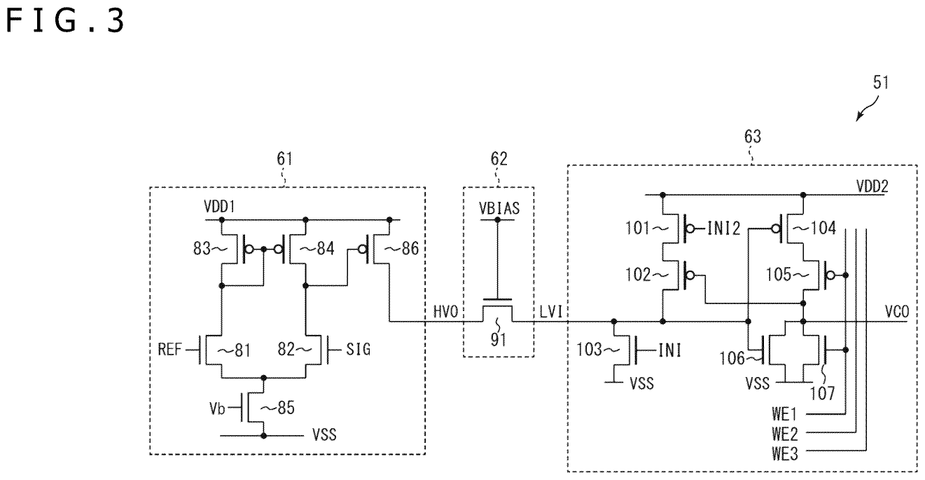

The comparison circuit 51 includes a differential input circuit 61, a voltage conversion circuit 62, and a positive feedback (PFB) circuit 63. The detailed configuration of the comparison circuit 51 will be explained later with reference to FIG. 3.

An output signal VCO is inputted from the comparison circuit 51 to the data storage section 52. Further, a WR signal (hereinafter, also referred to as a writing control signal WR) which indicates a pixel signal writing operation, an RD signal (hereinafter, also referred to as a reading control signal RD) which indicates a pixel signal reading operation, and a WORD signal for controlling a reading timing of a pixel 21 during a pixel signal reading operation, are supplied from the vertical driving circuit 27 to the data storage section 52. In addition, a clock-time code generated by the clock-time code generation section 26 is also supplied to the data storage section 52 via the clock-time code transfer sections 23.

The data storage section 52 includes a latch control circuit (storage control section) 71 that controls a clock-time code writing operation and a clock-time code reading operation on the basis of the WR signal and the RD signal, and a latch storage section 72 that stores a clock-time code.

In a clock-time code writing operation, while the output signal VCO at a high level is being inputted from the comparison circuit 51, the latch control circuit 71 causes the latch storage section 72 to store a clock-time code which is supplied from the clock-time code transfer section 23 and which is updated every unit time. Further, when (the voltage of) the reference signal REF becomes equal to (the voltage of) the pixel signal SIG and the output signal VCO being supplied from the comparison circuit 51 is inverted to a low level, writing (updating) a supplied time-clock code is stopped, and the last clock-time code stored in the latch storage section 72 is retained at the latch storage section 72. The clock-time code retained at the latch storage section 72 indicates a clock time when the pixel signal SIG has become equal to the reference signal REF. This code is data indicating that the voltage of the pixel signal SIG has been equal to the reference voltage at the clock time, that is, indicates a digitalized light quantity value.

After sweeping of the reference signal REF is finished and clock-time codes are retained in the latch storage sections 72 of all the pixels 21 in the pixel array section 22, the writing operation in each of the pixels 21 is switched to a reading operation.

In a clock-time code reading operation, when a reading timing of the pixel 21 comes, the latch control circuit 71 outputs a clock-time code (digital pixel signal) stored in the latch storage section 72 to the clock-time code transfer section 23 on the basis of a reading control signal RD and a WORD signal for controlling a reading timing. The clock-time code transfer section 23 sequentially transfers supplied clock-time codes in a reading direction (the column direction (vertical direction) toward the output section 28 in FIG. 1) so that the clock-time codes are supplied to the output section 28. In a certain case, the clock-time code transfer section 23 transfers the clock-time codes in units of clusters each including a few adjacent pixels.

### <Configuration Example of Comparison Circuit>

FIG. 3 is a circuit diagram depicting detailed configurations of the differential input circuit 61, the voltage conversion circuit 62, and the positive feedback circuit 63 included in the comparison circuit 51 in FIG. 2.

The differential input circuit 61 compares a pixel signal SIG outputted from the pixel circuit 41 in the pixel 21, with a reference signal REF outputted from the DAC 25, and outputs a prescribed signal (current) when the pixel signal SIG is higher than the reference signal REF.

The differential input circuit 61 includes transistors 81 and 82 which form a differential pair, transistors 83 and 84 constituting a current mirror, a transistor 85 serving as a constant current source for supplying a current IB according to an input bias current Vb, and a transistor 86 that outputs an output signal HVO of the differential input circuit 61.

The transistors 81, 82, and 85 are NMOS (Negative Channel MOS) transistors. The transistors 83, 84, and 86 are PMOS (Positive Channel MOS) transistors.

Regarding the transistors 81 and 82 which form a differential pair, a reference signal REF outputted from the DAC 25 is inputted to the gate of the transistor 81 while a pixel signal SIG outputted from the pixel circuit 41 in the pixel 21 is inputted to the gate of the transistor 82. The sources of the transistors 81 and 82 are connected to the drain of the transistor 85. The source of the transistor 85 is connected to a prescribed voltage VSS (VSS<VDD2<VDD1).

The drain of the transistor 81 is connected to the gates of the transistors 83 and 84 constituting a current mirror circuit and the drain of the transistor 83. The drain of the transistor 82 is connected to the drain of the transistor 84 and the gate of the transistor 86. The sources of the transistors 83, 84, and 86 are connected to a first power source voltage VDD1.

The voltage conversion circuit 62 includes a transistor 91 of, for example, an NMOS type. The drain of the transistor 91 is connected to the drain of the transistor 86 of the differential input circuit 61. The source of the transistor 91 is connected to a prescribed connection point in the positive feedback circuit 63. The gate of the transistor 91 is connected to a node of a bias voltage VBIAS.

The transistors 81 to 86 included in the differential input circuit 61 are circuits that operate with a high voltage up to the first power source voltage VDD1. The positive feedback circuit 63 is a circuit that operates with a second power source voltage VDD2 that is lower than the first power source voltage VDD1. The voltage conversion circuit 62 converts the output signal HVO inputted from the differential input circuit 61, to a low-voltage signal (converted signal) LVI, with which the positive feedback circuit 63 can operate, and then, supplies the low-voltage signal to the positive feedback circuit 63.

The bias voltage VBIAS may be set such that a converted voltage thereof does not destruct transistors 101 to 105 of the positive feedback circuit 63. For example, the bias voltage VBIAS may be equal to the second power source voltage VDD2 of the positive feedback circuit 63 (VBAIS=VDD2). The same voltage conversion effect can be obtained even when VBAIS=VDD2.

The positive feedback circuit 63 outputs a comparison result signal that is inverted when the pixel signal SIG is higher than the reference signal REF on the basis of the converted signal LVI obtained by converting the output signal HVO from the differential input circuit 61 to a signal corresponding to the second power source voltage VDD2. In addition, the positive feedback circuit 63 increases a transition speed at which the output signal to be outputted as a comparison result signal is inverted.

The positive feedback circuit 63 includes five transistors 101 to 107. The transistors 101, 102, 104, and 105 are PMOS transistors. The transistors 103, 106, and 107 are NMOS transistors.

The source of the transistor 91, which is at an output terminal of the voltage conversion circuit 62, is connected to the drains of the transistors 102 and 103 and the gates of the transistors 104 and 106. The sources of the transistors 101 and 104 are connected to the second power source voltage VDD2. The drain of the transistor 101 is connected to the source of the transistor 102. The gate of the transistor 102 is connected to the drains of the transistors 105 and 107 which are at an output terminal of the positive feedback circuit 63. The sources of the transistors 103, 106, and 107 are connected to a prescribed voltage VSS. An initialization signal INI2 is supplied to the gate of the transistor 101. An initialization signal INI is supplied to the gate of the transistor 103.

Any one of write enable signals WE1 to WE3, which will be explained later, is connected to the gates of the transistors 105 and 107. As will be explained later, each pixel in the pixel array section 22 belongs to any one of a plurality of pixel groups. The pixel groups have respective write enable signals. The positive feedback circuit 63 of each pixel outputs a valid VCO signal when the corresponding write enable signal is in an enabled state (e.g. low level). Therefore, in a case where the corresponding write enable signal is not in an enabled state, a valid VCO signal is not outputted from the positive feedback circuit 63. Accordingly, a clock-time code corresponding to pixel data is not stored into the post-stage latch storage section 72.

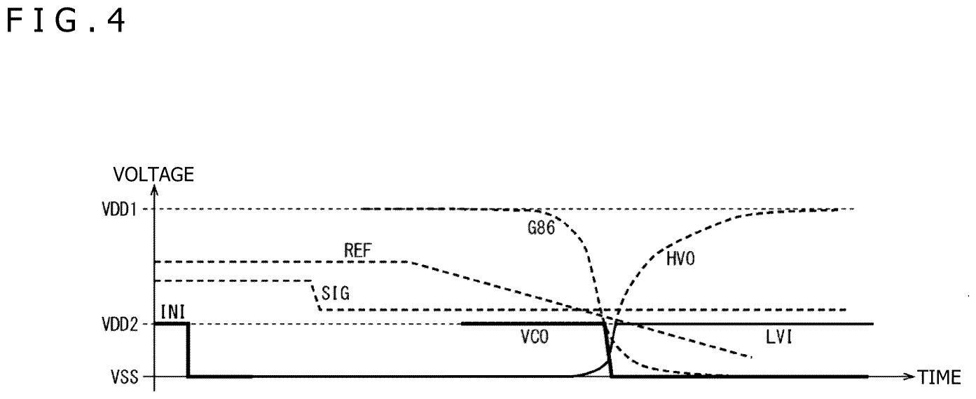

Operation of the comparison circuit 51 which has the above-mentioned configuration will be explained. FIG. 4 is a chart indicating transitions of signals when the comparison circuit 51 is under operation. It is to be noted that “G86” in FIG. 4 represents a gate potential of the transistor 86.

First, the voltage of a reference signal REF is set to be higher than the voltages of the pixel signals SIG of all the pixels 21, an initialization signal INI and an initialization signal INI2 (not indicated) are set at a high level, and the comparison circuit 51 is initialized.

More specifically, the reference signal REF and the pixel signal SIG are applied to the gate of the transistor 81 and the gate of the transistor 82 in FIG. 3, respectively. When the voltage of the reference signal REF is higher than the voltage of the pixel signal SIG, a most part of a current between the drain and the source of the transistor 85 which is a current source flows to the transistor 83 to which the transistor 85 is diode-connected via the transistor 81. The channel resistance of the transistor 84, which shares the gate with the transistor 83, is sufficiently decreased, the gate of the transistor 86 is maintained approximately at a first power source voltage VDD1 level. The transistor 86 is cut off. Therefore, the positive feedback circuit 63 which serves as a charging circuit, does not charge a conversion signal LVI even if the transistor 91 of the voltage conversion circuit 62 is in a conductive state. Meanwhile, since a high-level signal is supplied as the initialization signal INI to the positive feedback circuit 63, the transistor 103 becomes conductive and the positive feedback circuit 63 charges the conversion signal LVI. In this state, the initialization signal INI2 is at a high level and the transistor 101 is cut off, and thus, the positive feedback circuit 63 does not charge the conversion signal LVI via the transistor 102. As a result, the conversion signal LVI is discharged to a prescribed voltage VSS level, the positive feedback circuit 63 outputs the output signal VCO at a high level by means of the transistors 104 and 106 constituting an inverter, and the comparison circuit 51 is initialized. After the initialization, the initialization signals INI and INI2 are set to a low level to turn off the transistor 103, and sweeping the reference signal REF is started.

When the voltage of the reference signal REF is higher than that of the pixel signal SIG, the transistor 86 is off and in a cutoff state, and the output signal VCO goes high. Thus, the transistor 102 is also turned off and enters a cutoff state. The transistor 103 is also cut off because the initialization signal INI is at a low level. The conversion signal LVI is maintained at the prescribed voltage VSS while being in a high-impedance state, the output signal VCO at a high level is outputted.

When the reference signal REF becomes lower than the pixel signal SIG, the output current from the current source transistor 85 stops flowing through the transistor 81, the gate potentials of the transistors 83 and 84 are increased, and the channel resistance of the transistor 84 becomes high. Current flowing into the transistor 84 via the transistor 82 causes a voltage drop to decrease the gate potential of the transistor 86, so that the transistor 91 becomes conductive. The output signal HVO outputted from the transistor 86 is converted to the conversion signal LVI by the transistor 91 of the voltage conversion circuit 62, and the conversion signal LVI is supplied to the positive feedback circuit 63. The positive feedback circuit 63 which serves as a charging circuit, charges the conversion signal LVI to make the potential close to a second power source voltage VDD2 from the low voltage VSS.

Then, when the voltage of the conversion signal LVI exceeds a threshold voltage of the inverter including the transistors 104 and 106, the output signal VCO goes low, so that the transistor 102 becomes conductive. The transistor 101 is also conductive because the low-level initialization signal INI is being applied to the transistor 101. The positive feedback circuit 63 quickly charges the conversion signal LVI via the transistors 101 and 102 so that the potential is quickly increased to the second power source voltage VDD2.

A bias voltage VBIA is applied to the gate of the transistor 91 of the voltage conversion circuit 62. Therefore, when the voltage of the conversion signal LVI reaches a voltage value that is lower than the bias voltage VBIA by a threshold of the transistor, the transistor 91 is cut off. The conversion signal LVI is not charged to a voltage higher than the voltage value even if the transistor 86 remains conductive. Thus, the voltage conversion circuit 62 further functions as a voltage clamp circuit.

Charging the conversion signal LVI through the energization of the transistor 102, is a positive feedback operation that is started upon an increase of the conversion signal LVI to an inverter threshold, and then, is accelerated. In the transistor 85 which is a current source of the differential input circuit 61, current in each circuit is set to be very small because the number of circuits that concurrently, parallelly operate in the imaging device 1 is large. Furthermore, the reference signal REF is very gently swept because, during a unit time period of clock-time code switching, the voltage thereof changes by an LSB step of AD conversion. Therefore, the gate potential of the transistor 86 also changes gently. Accordingly, output current of the transistor 86 with is driven by the gate potential also changes gently. However, positive feedback from the post stage is performed on the conversion signal LVI that is charged up with the output current so that the transition speed of the output signal VCO becomes sufficiently high. It is desirable that the transition time period of the output signal VCO is one several-th of the unit time period of the clock-time code. The transition time period is typically 1 ns or less. To achieve such an output transition time period in the comparison circuit 51 according to the present disclosure, it is sufficient to set a small current that is 0.1 uA, for example, in the transistor 85 which is the current source.

### <Detailed Configuration Example of Pixel Circuit>

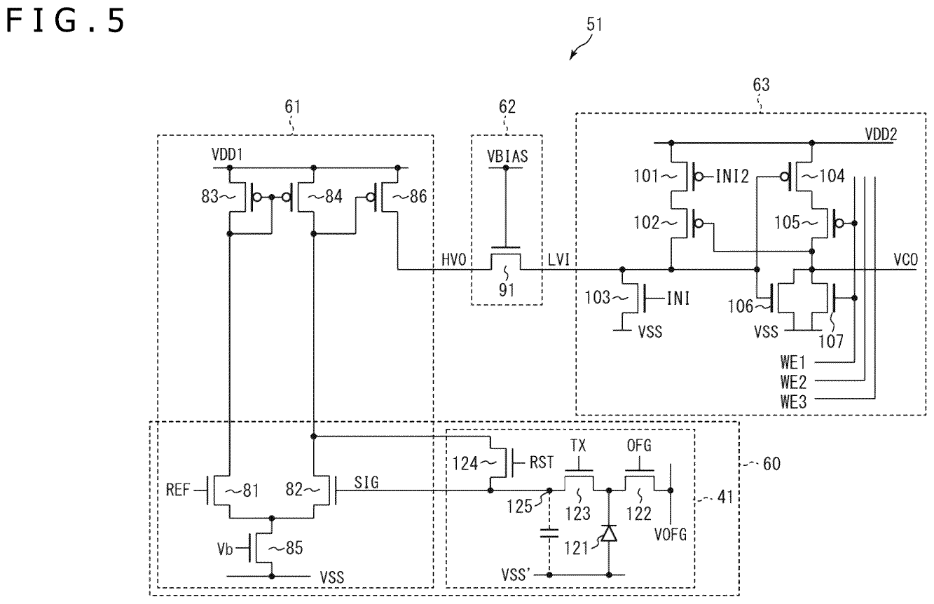

The detailed configuration of the pixel circuit 41 will be explained with reference to FIG. 5.

FIG. 5 is a circuit diagram obtained by adding the details of the pixel circuit 41 to the comparison circuit 51 depicted in FIG. 3.

The pixel circuit 41 includes a photodiode (PD) 121 which is a photoelectric conversion element, a discharge transistor 122, a transfer transistor 123, a reset transistor 124, and an FD (floating diffusion layer) 125. A grounding node VSS' for the pixel circuit 41 is disposed separately from a grounding node VSS for the differential input circuit 61 and the positive feedback circuit 63 of the comparison circuit 51.

The discharge transistor 122 is used to control an exposure time period. Specifically, the discharge transistor 122 is turned on to start an exposure time period at any timing, whereby electric charges stored in the photodiode 121 is discharged. Accordingly, the exposure time period is started from the turn-off timing of the discharge transistor 122.

The transfer transistor 123 transfers an electric charge generated by the photodiode 121, to the FD 125. The reset transistor 124 resets an electric charge retained by the FD 125. The FD 125 is connected to the gate of the transistor 82 of the differential input circuit 61. Therefore, the transistor 82 of the differential input circuit 61 functions as an amplification transistor of the pixel circuit 41.

The source of the reset transistor 124 is connected to the gate of the transistor 82 of the differential input circuit 61 and the FD 125. The drain of the reset transistor 124 is connected to the drain of the transistor 82. Therefore, there is no fixed reset voltage for resetting the electric charge in the FD 125. It is for this reason that a reset voltage for resetting the FD 125 can be optionally defined with the reference signal REF by controlling the circuit state of the differential input circuit 61.

### <Pixel Section Timing Chart>

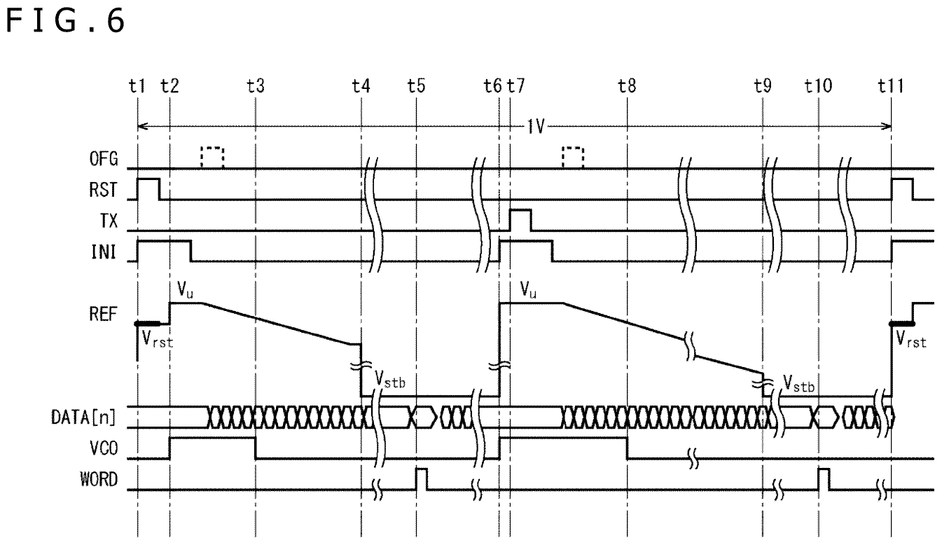

Operation of the pixel 21 including the comparison circuit 51 and the pixel circuit 41 in FIG. 5 will be explained with reference to a timing chart in FIG. 6.

First, at time t1, the reference signal REF is set from a stand-by voltage V_{stb} to a reset voltage Vᵣₛₜ for resetting an electric charge in the FD 125, and the reset transistor 124 is turned on, so that the electric charge in the FD 125 is reset. Further, at time t1, the initialization signal INI and the initialization signal INI2 (not indicated) being supplied to the gates of the transistors 101 and 103 of the positive feedback circuit 63 are set at a high level, so that the positive feedback circuit 63 is initialized.

At time t2, the reference signal REF is changed to a prescribed voltage Vᵤ, and comparison between the reference signal REF and the pixel signal SIG (sweeping the reference signal REF) is started. At this time point, the output signal VCO is at a high level because the reference signal REF is higher than the pixel signal SIG.

At time t3 when the reference signal REF is determined to be equal to the pixel signal SIG, the output signal VCO is inverted (goes low). After the output signal VCO is inverted, the speed of inversion of the output signal VCO is increased by the positive feedback circuit 63, as previously explained. In addition, the data storage section 52 holds clock-time data (N-bit clock-time codes DATA [1] to DATA [N]) at the inversion timing of the output signal VCO.

At time t4 at which a signal writing period ends and a signal reading period starts, the voltage of the reference signal REF being supplied to the gate of the transistor 81 of the comparison circuit 51 is lowered to a level (standby voltage V_{stb}) to turn off the transistor 81. Accordingly, current consumption in the comparison circuit 51 during the signal reading period is suppressed.

At time t5, the level of the WORD signal which controls a reading timing goes high, and the held N-bit clock-time codes DATA[1] to DATA[N] are outputted from the latch control circuit 71 of the data storage section 52. The clock-time codes obtained at time t5 is P-phase data at a reset level for performing CDS (Correlated Double Sampling).

At time t6, the reference signal REF is raised to a prescribed voltage Vᵤ and the level of the initialization signals INI and INI2 being supplied to the gates of the transistors 101 and 103 respectively is set to be high, whereby the positive feedback circuit 63 restores the initial state.

At time t7, the transfer transistor 123 of the pixel circuit 41 is turned on by a transfer signal TX at a high level, and the electric charge stored in the photodiode 121 is transferred to the FD 125.

The initialization signal INI and the initialization signal INI2 which is not indicated in the drawing, are restored to a low level, and then, comparison between the reference signal REF and the pixel signal SIG (sweeping of the reference signal REF) is started. At this time point, the output signal VCO is at a high level because the reference signal REF is higher than the pixel signal SIG.

Then, at time t8 when the reference signal REF and the pixel signal SIG which is not indicated in the drawing are determined to become equal to each other, the output signal VCO is inverted (goes low). Once the output signal VCO is inverted, inversion of the output signal VCO is accelerated by the positive feedback circuit 63. In addition, the clock-time data (N-bit clock-time codes DATA[1] to DATA[N]) at the time point of the inversion of the output signal VCO are held (stored) in the data storage section 52.

At time t9 when the signal writing period ends and the signal reading period starts, the voltage of the reference signal REF being supplied to the gate of the transistor 81 of the comparison circuit 51 is lowered to a level (standby voltage V_{stb}) to turn off the transistor 81. Accordingly, current consumption in the comparison circuit 51 during the signal reading period is suppressed.

At time t10, the WORD signal that controls the reading timing goes high, and the held (stored) N-bit clock-time codes DATA[1] to DATA[N] are outputted from the latch control circuit 71 of the data storage section 52. The clock-time codes obtained at time t10 is D-phase data at a signal level for performing CDS. The state at time t11 is the same as that at time t1. At time t11, driving of new one V (one vertical scanning period) starts.

According to the above-mentioned driving of the pixel 21, P-phase data the reset-level is first obtained and read, and then, a D-phase data at the signal level is obtained and read.

As a result of the above-mentioned operations, all the pixels 21 in the pixel array section 22 of the imaging device 1 are simultaneously reset, so that global shutter operation of exposing all pixels at the same time can be performed. Since exposure and reading can be performed at all the pixels at the same time, the need for a retaining section that is commonly disposed in a pixel and retains an electric charge until the electric charge is read, is eliminated. Further, the configuration of the pixel 21 eliminates the need for a selection transistor or the like, which has been necessary in a column parallel read type imaging device 1, for selecting a pixel to output a pixel signal SIG.

In driving of the pixel 21 having been explained with reference to FIG. 6, the discharge transistor 122 is controlled to be constantly off. However, an optional exposure time period may be determined by setting a discharge signal OFG high to turn on the discharge transistor 122 at a desired time, and then, turning off the discharge transistor 122, as indicated by broken lines in FIG. 6.

### <Data Storage Section and Clock-Time Code Transfer Section>

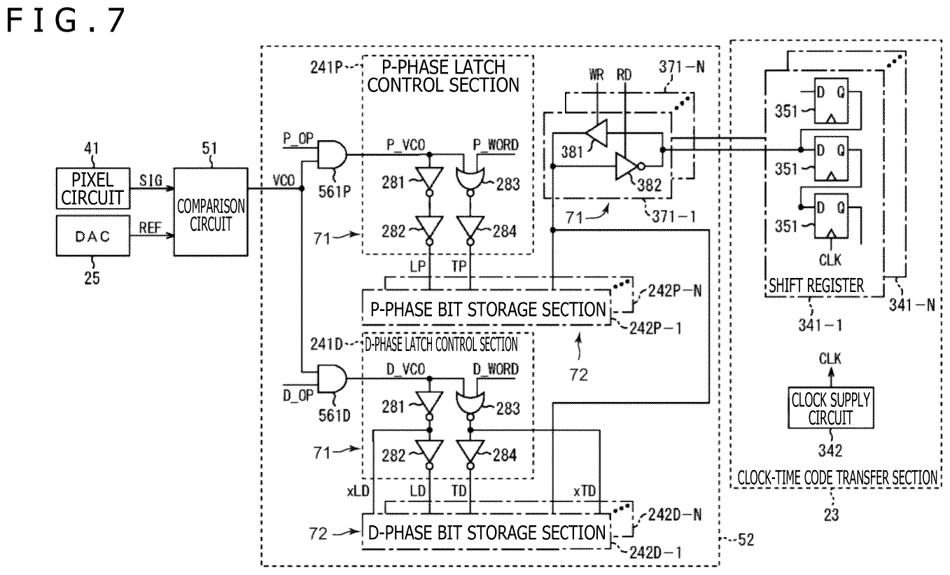

FIG. 7 is a circuit diagram depicting a specific configuration of the clock-time code transfer section 23 and the data storage section 52. The clock-time code transfer section 23 includes a clock supply circuit 342 and N shift registers 341-1 to 341-N which correspond to the N-bit time-clock codes DATA[1] to DATA[N]. Each of the N shift registers 341-1 to 341-N is formed of a plurality of D-F/F (D-flip flops) 351. The clock supply circuit 342 supplies a clock signal CLK to a clock input of each of the D-F/Fs 351 of the shift register 341. In a case where clock-time codes are transferred in units of clusters each including a few adjacent pixels 21 in the above-mentioned manner, the number of the D-F/Fs 351 included in each shift register 341 of the clock-time code transfer section 23 depends on the number of the clusters.

The latch control circuit 71 of the data storage section 52 includes a P-phase latch control section 241P for P-phase data, a D-phase latch control section 241D for D-phase data, and N bidirectional buffer circuits 371-1 to 371-N. In addition, the latch storage section 72 of the data storage section 52 includes P-phase bit storage sections 242P-1 to 242P-N for P-phase data, and D-phase bit storage sections 242D-1 to 242D-N for D-phase data.

The N bidirectional buffer circuits 371-1 to 371-N are disposed in one-to-one correspondence to the N shift registers 341-1 to 341-N of the clock-time code transfer section 23. Each bidirectional buffer circuit 371 is connected to one of the D-F/Fs 351 of the corresponding shift register 341.

A writing control signal WR which is at a high level in a clock-time code writing operation is supplied to the buffer circuit 381 of the bidirectional buffer circuit 371-N (0<n<N+1). A reading control signal RD which is at a high level in a clock-time code reading operation is supplied to the inverter circuit 382. The bidirectional buffer circuit 371-N performs switching between the clock-time code writing operation and the clock-time code reading operation with respect to the P-phase bit storage sections 242P-1 to 242P-N and the D-phase bit storage sections 242D-1 to 242D-N according to the writing control signal WR and the reading control signal RD.

Further, the data storage section 52 includes two AND circuits 561P and 561D. The output signal VCO outputted from the comparison circuit 51 is inputted to one of two inputs of the AND circuit 561P and one of two inputs of the AND circuit 561D. A P-phase selection signal P_OP which is at a high level during an AD conversion period of P-phase data is inputted to the other one of the two inputs of the AND circuit 561P. A D-phase selection signal D_OP which is at a high level during an AD conversion period of D-phase data is inputted to one of the two inputs of the AND circuit 561D.

The P-phase latch control section 241P and the D-phase latch control section 241D each can include two inverters 281 and 282 that are connected in series, and a NOR circuit 283 and an inverter 284 that are connected in series.

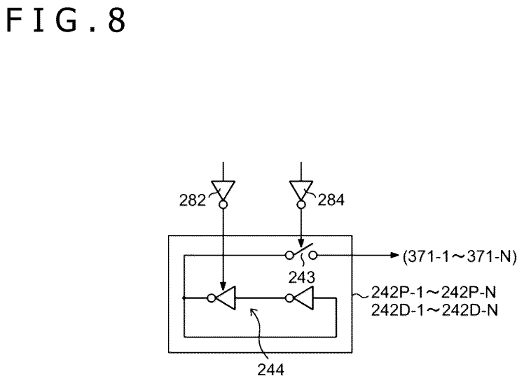

The P-phase bit storage sections 242P-1 to 242P-N and the D-phase bit storage section 242D-1 to 242D-N of the data storage section 52 each include a switch 243 and a latch circuit 244, as depicted in FIG. 8. Switching of the switch 243 in each of the P-phase bit storage sections 242P-1 to 242P-N is controlled by an output from the corresponding inverter 284 in the P-phase latch control section 241P. Switching of the switch 243 in each of the D-phase bit storage sections 242D-1 to 242D-N is controlled by an output from the corresponding inverter 284 in the D-phase latch control section 241D. Whether or not to cause the latch circuits 244 in the P-phase bit storage sections 242P-1 to 242P-N to latch respective clock-time codes outputted from the bidirectional buffer circuits 371-1 to 371-N, is controlled by an output from the corresponding inverter 282 in the P-phase latch control section 241P. Whether or not to cause the latch circuits 244 in the D-phase bit storage sections 242D-1 to 242D-N to latch respective clock-time codes outputted from the bidirectional buffer circuits 371-1 to 371-N, is controlled by an output from the corresponding inverter 282 in the D-phase latch control section 241D. The latch circuit 244 may be formed of a semiconductor memory such as an SRAM (Static Random Access Memory) which is formed of a plurality of transistors, for example. If so, the P-phase latch control section 241P and the D-phase latch control section 241D need to have respective control circuit configurations that are optimal for the configuration of the adopted semiconductor memory. From the viewpoint of placing these sections in a limited area, it is desirable to combine the P-phase latch control section 241P and the D-phase latch control section 241D as combinational circuits rather than as sequential circuits.

The output signal VCO which is an output from the comparison circuit 51 is inputted to the respective inverters 281 and the respective NOR circuits 283 of the P-phase latch control section 241P and the D-phase latch control section 241D. A P_WORD signal/D_WORD signal is inputted to the other input of each NOR circuit 283. An output signal from the inverter 281 is inverted by the inverter 282, and latch control of the latch circuits 244 of the P-phase bit storage sections 242P-1 to 242P-N and latch control of the latch circuits 244 of the D-phase bit storage section 242D-1 to 242D-N are performed. The output signal from the NOR circuit 283 is inverted by the inverter 284, and switching control of the switches 243 of the P-phase bit storage sections 242P-1 to 242P-N and latch control of the switches 243 of the D-phase bit storage section 242D-1 to 242D-N are performed.

Two AND circuits 561P and 561D are disposed in the data storage section 52. The output signal VCO outputted from the comparison circuit 51 is inputted to one of two inputs of the AND circuit 561P and one of two inputs of the AND circuit 561D. A P-phase selection signal P_OP which is at a high level during an AD conversion period of P-phase data is inputted to the other one of the two inputs of the AND circuit 561P. A D-phase selection signal D_OP which is at a high level during an AD conversion period of D-phase data is inputted to one of the two inputs of the AND circuit 561D.

In the data storage section 52 in FIG. 7, in the first AD conversion period of P-phase data, the P-phase selection signal P_OP at a high level and the D-phase selection signal D_OP at a low level are supplied to the data storage section 52, and P-phase data is stored in the P-phase bit storage sections 242P-1 to 242P-N.

In the following AD conversion period of D-phase data, the P-phase selection signal P_OP at a low level and the D-phase selection signal D_OP at a high level are supplied to the data storage section 52, and D-phase data is stored in the D-phase bit storage sections 242D-1 to 242D-N. Then, the P-phase data and the D-phase data are outputted sequentially to the clock-time code transfer section 23.

Accordingly, with the data storage section 52 in FIG. 7, a time interval between obtainment of P-phase data and obtainment of D-phase data can be shortened so that an offset and noise canceling effect by CDS can be enhanced. In addition, since P-phase data and D-phase data are outputted sequentially to the clock-time code transfer section 23, the need for a memory section that temporarily stores P-phase data is eliminated from the output section 28.

In a clock-time code writing operation, the WORD signal is at a low level in all the pixels, and the switch 243 is on when the output signal VCO is at high level, and the switch is off when the output signal VCO is at a low level. A feedback (output xQ in response to an input Q) of the latch storage section 72 is off when the output signal VCO is at a high level, and the feedback is on when the output signal VCO is at a low level. Therefore, the latch storage section 72 is in a state (transparent state) of writing a n-th bit clock-time code when the output signal VCO is at a high level, and the latch storage section 72 is in a state (latching state) of retaining the written clock-time code through the bidirectional buffer circuit 371-N when the output signal VCO is at a low level.

In a clock-time code reading operation, a WORD signal at a high level is supplied only to the P-phase latch control section 241P and the D-phase latch control section 241D in the pixel 21 to be read. Since the output signal VCO is at a low level, the switch 243 is on only when the WORD signal at a high level is inputted, and a clock-time code retained in the latch storage section 72 is outputted to the clock-time code transfer section 23 through the bidirectional buffer circuit 371-N.

In the AD conversion period in which the reference signal REF is swept, the N shift registers 341 of the clock-time code transfer section 23 transfer the clock-time codes supplied from the clock-time code generation section 26 by a shift clock the clock cycle of which is a unit time of the clock-time code.

In the clock-time code writing operation, the writing control signal WR at a high level and the reading control signal RD at a low level are supplied to the bidirectional buffer circuit 371, and the bidirectional buffer circuit 371 stores a clock-time code supplied from a prescribed one of the D-F/Fs 351 of the shift register 341, into the P-phase bit storage sections 242P-1 to 202P-N or the D-phase bit storage sections 242D-1 to 242D-N.

In the following clock-time code reading operation, the writing control signal WR at a low level and the reading control signal RD at a high level are supplied to the bidirectional buffer circuit 371, the clock-time code stored in the P-phase bit storage sections 242P-1 to 202P-N or the D-phase bit storage section 242D-1 to 242D-N is supplied to a prescribed one of the D-F/Fs 351 of the shift register 341 of the clock-time code transfer section 23 via the bidirectional buffer circuit 371. The shift register 341 sequentially transfers clock-time data supplied to the D-F/Fs 351, to the output section 28 to output the clock-time data.

More specifically, each of the D-F/Fs 351 of the shift register 341 is configured to enter a high impedance state (hereinafter, referred to as Hi-Z state) when the clock signal CLK being supplied to the clock input is at a high level or a low level. For example, in the configuration of the D-F/Fs 351 in FIG. 7, each D-F/F 351 is in the Hi-Z state when the clock signal CLK is at a low level.

While each of the D-F/Fs 351 of the shift register 341 is in the Hi-Z state, the reading control signal RD at a high level is supplied to the bidirectional buffer circuit 371, and the WORD signal goes high to supply the clock-time code stored in the bit storage section 242 to a prescribed one of the D-F/Fs 351 of the shift register 341 of the clock-time code transfer section 23 via the bidirectional buffer circuit 371.

After the reading control signal RD is restored to a low level, a shift clock is supplied to each of the D-F/Fs 351 of the shift register 341, and the shift register 341 sequentially transfers the clock-code data supplied to the D-F/Fs 351 to the output section 28 to output the clock-time data.

FIG. 7 depicts an example in which the latch circuits 244 of the P-phase bit storage sections 242P-1 to 242P-N and the latch circuits of the D-phase bit storage sections 242D-1 to 242D-N are formed of digital memories. Alternatively, these latch circuits may be formed of analog memories.

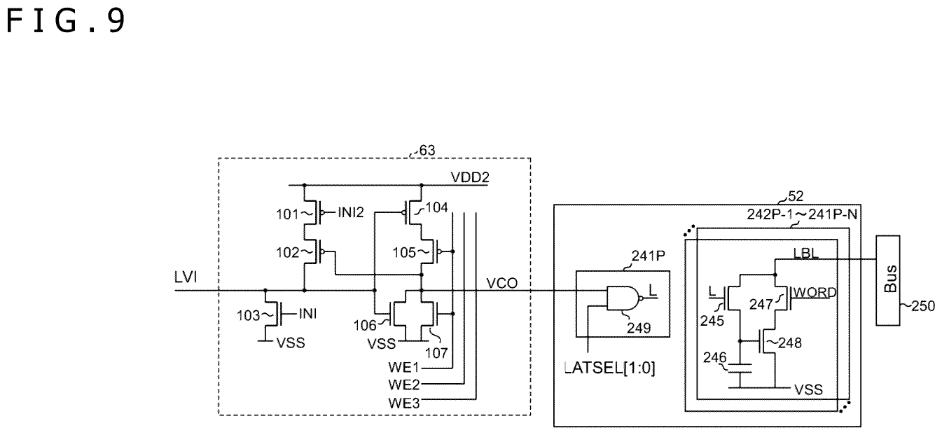

FIG. 9 is a circuit diagram depicting an example in which the latch circuits 244 of the P-phase bit storage sections 242P-1 to 242P-N and the latch circuits 244 of the D-phase bit storage sections 242D-1 to 242D-N are formed of analog memories. FIG. 9 depicts the P-phase latch control section 241P and the P-phase bit storage sections 242P-1 to 242P-N. The D-phase latch control section 241D and the D-phase bit storage sections 242D-1 to 242D, which are omitted in FIG. 9, have the same configuration. The P-phase bit storage sections 242P-1 to 242P-N and 242D-1 to 242D-N in FIG. 9 are formed of analog memories.

More specifically, the P-phase bit storage sections 242P-1 to 242P-N in FIG. 9 each include a transistors 245 and a capacitor 246 that are connected in series between a local bit line LBL and a grounding node, and a transistor 247 and a transistor 248 that are connected in series between the local bit line LBL and the grounding node. The transistors 245, 247, and 248 are NMOS transistors, for example. The source of the transistor 245 is connected to the gate of the transistor 248, and an output signal L of the latch control section 241P is inputted to the gate of the transistor 245.

FIG. 9 depicts a simplified internal configuration of the latch control section 241P. The latch control section 241P is provided with a NAND gate 249, for example. The NAND gate 249 outputs a high-level signal when either one of the output signal VCO of the positive feedback circuit 63 and a P-phase/D-phase selection signal LATSEL[1:0] is at a high level. When the output from the latch control section 241P goes high, the transistor 245 of each of the P-phase bit storage sections 242P to 242P-N is turned on to store an electric charge corresponding to the clock-time code into the capacitor 246. When the output of the NAND gate 249 of the latch control section 241P goes low, the transistor 245 is turned off and the stored electric charge is retained in the capacitor 246. In this state, a voltage corresponding to the stored electric charge in the capacitor 246 is being applied to the gate of the transistor 248, but the voltage level of the local bit line LBL remains unchanged because the second transistor 247 is off.

Thereafter, when the WORD signal goes high, the second transistor 247 is turned on, the local bit line LBL achieves a voltage level corresponding to the stored electric charge in the capacitor 246, the clock-time code stored in each of the P-phase bit storage sections 242P-1 to 242P-N is read out to a bus 250 via the local bit line LBL.

In the imaging device 1 according to the present embodiment, a plurality of pixels in the pixel array section 22 is divided into at least two pixel groups, and a timing of updating data stored in the latch storage sections 72 of the respective pixels is controlled in each of the pixel groups.

More specifically, the latch control circuits 71 of the data storage section 52 depicted in FIG. 2 perform control to cause the latch storage sections 72 to store data, and whether or not to update the data stored in the latch storage sections 72 is controlled in each of the pixel groups. In a pixel group, among the plurality of pixel groups, in which transfer of data of all the pixels to the output section 28 is not completed within one frame period, the latch control circuit 71 keeps retaining the pixel data therein without updating the pixel data in the latch storage sections 72, and resumes the transfer of the pixel data to the output section 28 in the following frame period.

### <Plurality of Pixel Groups>

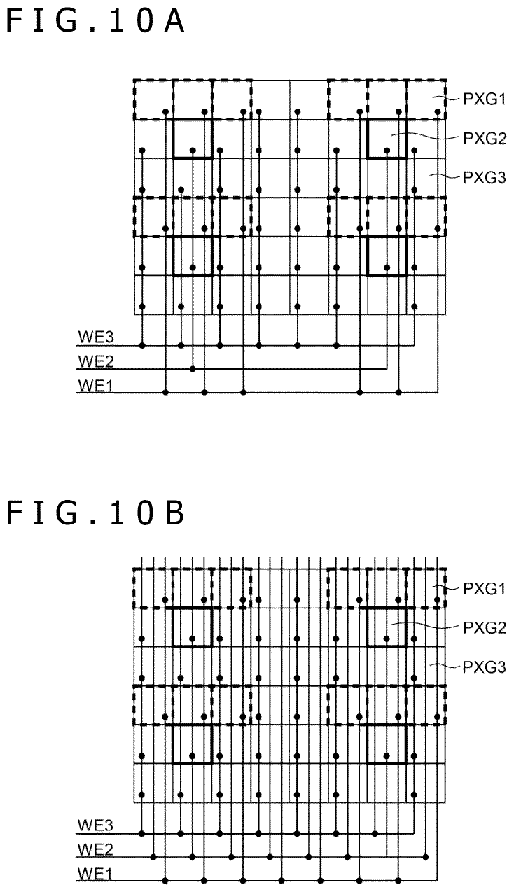

FIG. 10A is a diagram depicting one example of pixel groups in the pixel array section 22. FIG. 10A depicts an example in which the pixel array section 22, in which eight pixels are arranged in the horizontal direction and six pixels are arranged in the vertical direction, includes a first pixel group PXG1 which is indicated by broken lines, a second pixel group PXG2 which is indicated by heavy lines, and a third pixel group PXG3 which is indicated by thin lines, for simplification. The number of pixels in the pixel array section 22, and the number of pixel groups in the pixel array section 22 are optionally determined.

The first pixel group PXG1 includes a set each including three pixels from the left end and a set including three pixels from the right end in the horizontal direction, and these sets are arranged with spacing of two pixels in the vertical direction. The second pixel group PXG2 includes four pixels in total, and these pixels are arranged with spacing of four pixels in the horizontal direction and two pixels in the vertical direction. The third pixel group PXG3 includes the remaining pixels except for the pixels of the first pixel group PXG1 and the second pixel group PXG2 in the pixel array section 22.

The pixels of the first pixel group PXG1 are pixels for live view (videos), for example. The resolution of live view needs not to be as high as that of still images. Thus, the first pixel group PXG1 from which the pixels for still pictures have been cut out and which includes several pixels is used for live view.

The pixels of the second pixel group PXG2 are pixels for detecting an image plane phase difference. Each of the pixels is split into two parts, or a half of each of the pixels is shaded, and a phase difference is detected from optical signals imaged in the respective split areas. The phase difference is used for focus adjustment, for example.

The pixels of the third pixel group PXG3 are used for capturing a still picture, for example. Image roughness is easily noticeable in still pictures. Thus, it is desirable that the number of pixels of the third pixel group PXG3 is greater than that of the first pixel group PXG1 or the second pixel group PXG2.

The present embodiment has a first write enable signal WE1 that permits the latch storage sections 72 to store pixel signals of the corresponding pixels of the first pixel group PXG1, a second write enable signal WE2 that permits the latch storage sections 72 to store pixel signals of the corresponding pixels of the second pixel group PXG2, and a third write enable signal WE3 that permits the latch storage sections 72 to store pixel signals of the corresponding pixels of the third pixel group PXG3, as depicted in FIG. 10A. One of the first to third write enable signals WE1 to WE3 is connected to the gates of the transistors 105 and 107 of the positive feedback circuit 63 in FIG. 5, in each of the pixels. In the pixels belonging to the same pixel group, a write enable signal of the same type is connected to the gates of the transistors 105 and 107.

When the first write enable signal WE1 enters an enabled state (e.g., at a high level), pixel data (more specifically, clock-time codes corresponding to the pixel signals) of all the pixels of the first pixel group PXG1 are stored into the corresponding latch storage sections 72. Accordingly, the pixel data having already been stored in the latch storage sections 72 are updated.

Also, when the second write enable signal WE2 enters an enabled state (e.g., at a high level), pixel data of all the pixels of the second pixel group PXG2 are stored into the corresponding latch storage sections 72. Accordingly, the pixel data having already been stored in the latch storage sections 72 are updated.

Also, when the third write enable signal WE3 enters an enabled state (e.g., at a high level), pixel data of all the pixels of the third pixel group PXG3 are stored into the corresponding latch storage sections 72. Accordingly, the pixel data having already been stored in the latch storage sections 72 are updated.

If transfer of the pixel data stored in the latch storage sections 72 of the pixels of the first pixel group PXG1, the second pixel group PXG2, and the third pixel group PXG3 to the output section 28 can be completed within one frame period, the pixel data in the latch storage sections 72 of the respective pixels is not needed any more in the following frame period. Accordingly, the latch storage sections 72 can store new pixel data. However, in a region such as the third pixel group PXG3 where the number of pixels is large, there is a possibility that transfer of the pixel data of all the pixels to the output section 28 is not completed within one frame period. In particular, in a case where the number of pixels in the pixel array section 22 is large and the number of pixels in the third pixel group PXG3 is also large, there is concern that transfer of the pixel data in the latch storage sections 72 of the pixels of the third pixel group PXG3 to the output section 28 is not completed in one frame period. Also, in a case where the signal reading time in the pixels of the third pixel group PXG3 is long, there is concern that transfer of all the pixel data to the output section 28 is not completed within one frame period.

To this end, write enable signals are prepared for the respective pixel groups in the present embodiment, so that whether or not to update the pixel data in the latch storage sections 72 of the respective pixels, is determined for each of the pixel groups.

In FIG. 10A, a control wire for the first write enable signal WE1, a control wire for the second write enable signal WE2, and a control wire for the third write enable signal WE3 are arranged on pixels to which a writing permission is given such that the wires are not arranged on the pixels to which a writing permission is not given, if possible. Contacts which are black dots on the control wires in FIG. 10A, represent pixels that are under control of the corresponding write enable signals. Any one of the first to third write enable signals WE1 to WE3 is connected to each of the pixels in the pixel array section 22.

In a case where the three control wires are arranged as depicted in FIG. 10A, there is an advantage that the arrangement area of the control wires can be reduced and the opening ratio of each pixel can be improved, but the wire density becomes ununiform due to variation of the arrangement density of the control wires depending on positions in each pixel groups. Accordingly, irregularity in pixel characteristics such as sensitivity irregularity may be generated.

FIG. 10B is a diagram depicting one modification of FIG. 10A. FIG. 10B depicts an example in which the three control wires are arranged on each of the pixels in the pixel array section 22. In FIG. 10B, since the three control wires are arranged on each of the pixels in the pixel array section 22, the arrangement density of the control wires is uniform and the opening ratios of the pixels are equal.

The pixel groups may adopt the common order of reading pixel data of the pixels in the pixel array section 22, or may adopt different orders.

### <Reading Order in Pixel Group>

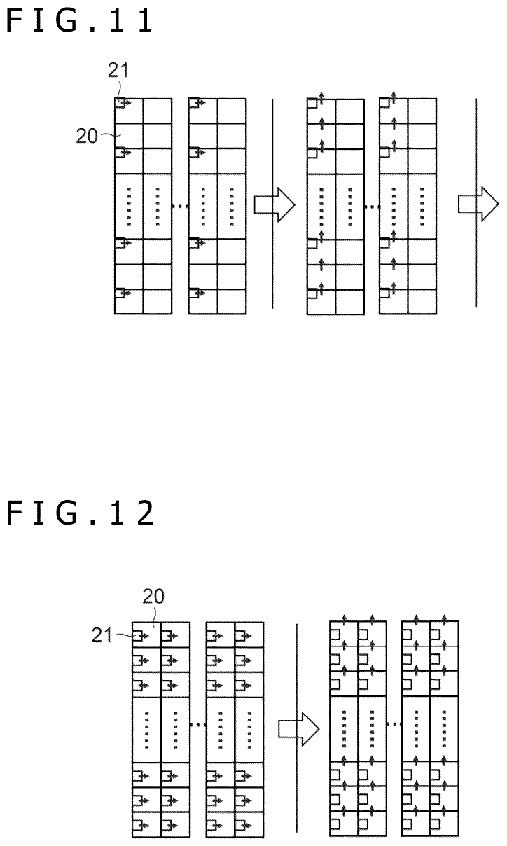

In the imaging device 1 according to the present embodiment, AD conversion and transfer of pixel data (specifically, a clock-time code corresponding to a pixel signal) are performed in units of clusters 20 each including a few pixels in the pixel array section 22, as depicted in FIG. 1. Hereinafter, an explanation will be given of a pixel data reading order of the first pixel group PXG1 that is formed by selecting every other cluster 20 in the horizontal direction and the vertical direction from among the clusters 20 in the pixel array section 22, and selecting a pixel at the upper left end of each of the selected clusters 20. FIG. 11 is a diagram in which a pixel data reading order of the pixels of the first pixel group PXG1 is indicated by arrows. FIG. 11 depicts that data of the pixels at the respective upper left ends of the clusters 20 of the first pixel group PXG1 are read and outputted to the upper side. The data of the pixels at the respective upper left ends of the clusters 20 to be transferred by the same clock-time code transfer section 23, are simultaneously read and transferred. FIG. 11 depicts the pixel data reading order of the pixels at the left ends of the respective clusters 20, but other pixel data are read in the similar manner.

FIG. 12 is a diagram in which a pixel data reading order of the second pixel group PXG2 that includes multiple clusters 20 that are arranged side by side in the horizontal direction and vertical direction. FIG. 12 depicts that pixel data of the pixels at the second row from the top in each of the clusters of the second pixel group PXG2 are simultaneously read, and transferred to the upper side. Other pixel data in each of the clusters 20 are also read in the similar manner as that in FIG. 12.

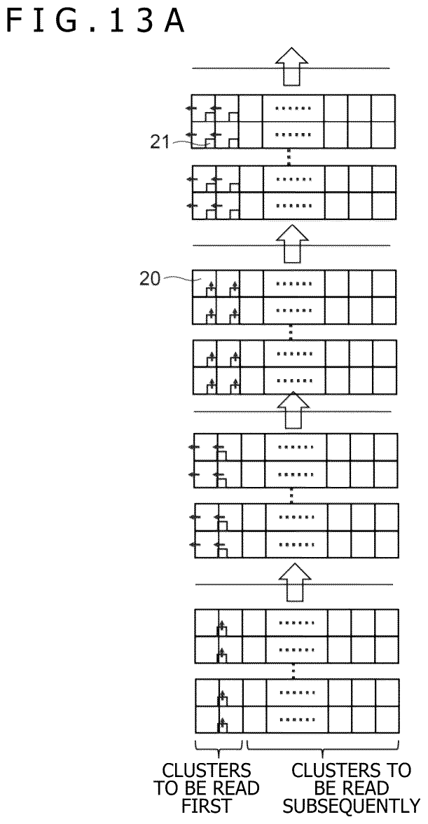

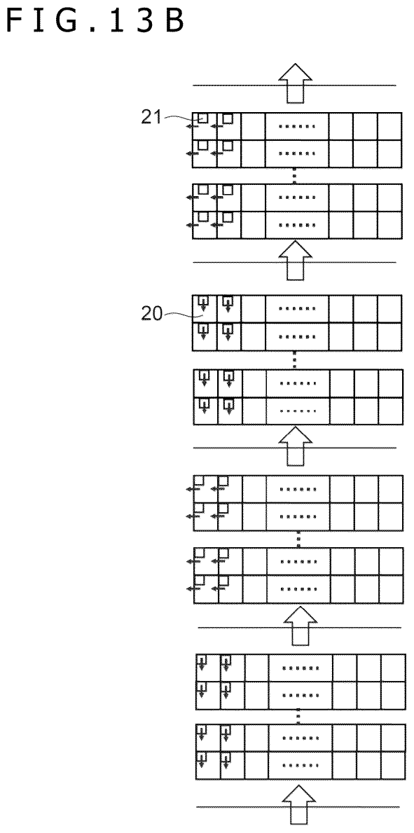

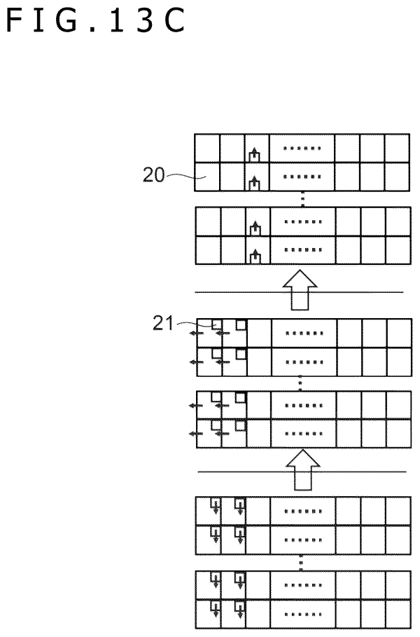

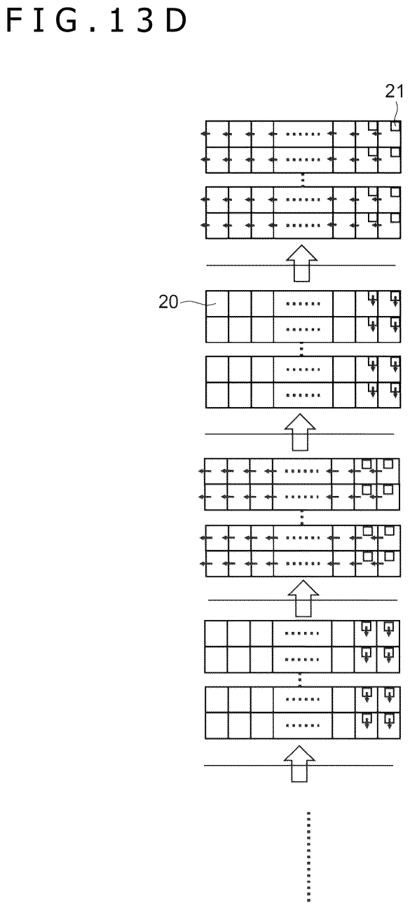

FIGS. 13A, 13B, 13C, and 13D are diagrams in each of which a pixel data reading order of the third pixel group PXG3 that includes the remaining pixels except the first pixel group PXG1 and the second pixel group PXG2 in the pixel array section 22. In FIGS. 13A to 13D, the clusters 20 that are arranged in the two rows on the top in the pixel array section 22 are read first, and then, the clusters 20 on the third and subsequent rows are read. In FIGS. 13A to 13D, pixel data of pixels at the same position in the respective clusters 20 are simultaneously read.

A plurality of the clusters 20 is disposed on the left and right sides of each clock-time code transfer section 23, as depicted in FIG. 1. Thus, in the clusters 20 that are disposed on the left side of the clock-time code transfer section 23, the pixel data are read rightward to the clock-time code transfer section 23, and then, are supplied to the output section 28. In the clusters 20 that are disposed on the right side of the clock-time code transfer section 23, the pixel data are read leftward to the clock-time code transfer section 23, and then, are supplied to the output section 28.

FIGS. 11, 12, and 13A to 13D each depict mere one example of the pixel data reading order of the multiple clusters 20 in the pixel array section 22. A variety of modifications can be made.

Local bit lines LBL may be disposed on the both sides of the clock-time code transfer section 23. Alternatively, a local bit line LBL may be disposed on one side of the clock-time code transfer section 23.

### <Timing of Reading Pixel Data>

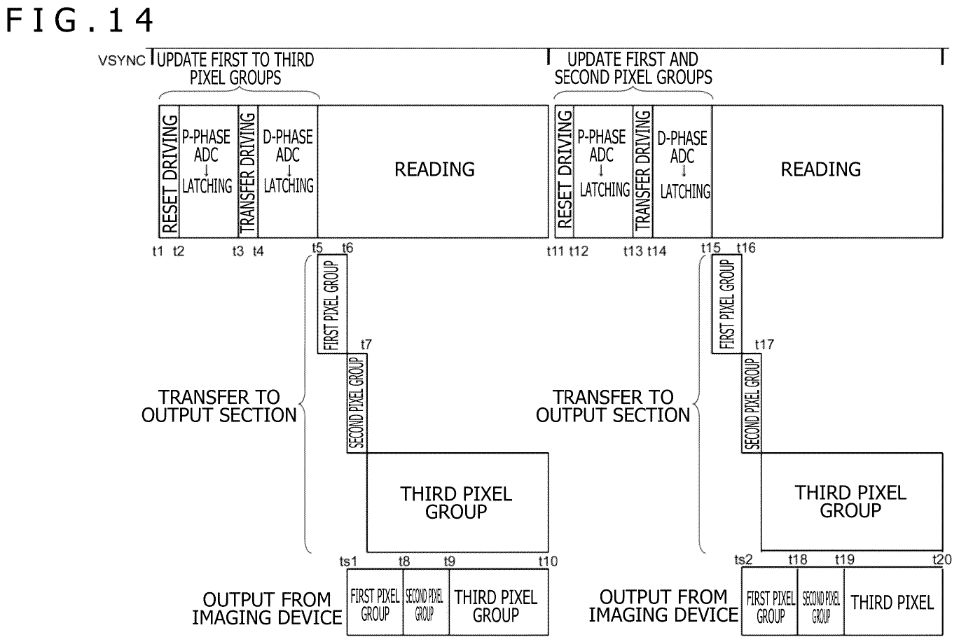

FIG. 14 is a timing chart in the imaging device 1 according to the present embodiment. FIG. 14 indicates timings in two frame periods. Each frame represents a period from output of a certain vertical synchronization signal VSYNC to output of the next vertical synchronization signal VSYNC. The first frame period is from time t1 to t10. The next frame period is from time t11 to t20. FIG. 14 indicates an example in which the pixel array section 22 includes the first pixel group PXG1, the second pixel group PXG2, and the third pixel group PXG3 depicted in FIGS. 10A and 10B.

First, during a period from time t1 to t2, the reset transistor 124 depicted in FIG. 5 is on and the potential of the FD 125 is at a reset level. At time t2, the reset transistor 124 is turned off.

Then, during a period from time t2 to t3, AD conversion is performed, at the reset level, on all the pixels in the pixel array section 22, and P-phase pixel data (specifically, clock-time codes corresponding to the reset level) are stored into the P-phase bit storage sections 242P-1 to 242P-N in FIG. 7.

Then, at time t3, the transfer transistors 123 of all the pixels in the pixel array section 22 are turned on, and an electric charge stored in the photodiode 121 is transferred to the FD 125 (time t3 to t4).

Then, during a period from time t4 to t5, AD conversion of photoelectrically converted pixel signals is performed in all the pixels in the pixel array section 22, and D-phase pixel data (specifically, clock-time codes corresponding to the pixel signals) are stored into the D-phase bit storage sections 242D-1 to 242D-N in FIG. 7. During the period from time t4 to t5, CDS for obtaining the difference between the D-phase pixel data and the P-phase pixel data may be performed.

Therefore, during the period from time t1 to t5, all the pixels in the pixel array section 22 are simultaneously under operation, and the P-phase and D-phase pixel data of each pixel are stored into the P-phase bit storage sections 242P-1 to 242P-N and the D-phase bit storage sections 242D-1 to 242D-N.

Then, during a period from time t5 to t6, the latch storage sections 72 in which writing has been conducted under control of the first write enable signal WE1 enter a selection state by corresponding WORD selection control, whereby pixel data of the pixels belonging to the first pixel group PXG1 in the pixel array section 22 are transferred from the latch storage sections 72 to the output section 28 via the clock-time code transfer section 23. In a case where CDS has been already performed in the period from time t4 to t5, post-CDS pixel data is transferred to the output section 28. On the other hand, in a case where CDS has not been performed in the period from time t4 to t5, the P-phase and D-phase pixel data are transferred to the output section 28, and then, are subjected to CDS at the output section 28.

Then, the latch storage sections 72 in which writing has been conducted under control of the second write enable signal WE1 enter a selection state by corresponding WORD selection control, whereby pixel data of the pixels belonging to the second pixel group PXG2 in the pixel array section 22 are transferred from the latch storage sections 72 to the output section 28 via the clock-time code transfer section 23.

Besides the above-mentioned CDS, digital signal processing such as black level correction for correcting the black level, is performed at the output section 28. After the digital signal processing, the pixel data is outputted to the outside of the imaging device 1. In the case of FIG. 14, the pixel data of the first pixel group PXG1 is outputted from the imaging device 1 in a period from time ts1 to t8, and the pixel data of the second pixel group PXG2 is outputted from the imaging device 1 in a period from time t8 to t9.

Then, during a period from time t9 to t10, pixel data of the pixels belonging to the third pixel group PXG3 in the pixel array section 22 are transferred from the latch storage sections 72 to the output section 28 via the clock-time code transfer section 23. Transferring the pixel data takes time because the number of pixels belonging to the third pixel group PXG3 is greater than those of the first pixel group PXG1 and the second pixel group PXG2. FIG. 14 depicts a case where transfer of the pixel data of the third pixel group PXG3 is not completed by time t10 which is the end of the first frame period.

The next frame period starts at time t11. During a period from time t11 to t12, which is similar to the period from time t1 to t2, the reset transistor 124 is on and the potential of the FD 125 is at the reset level. During a period from time t12 to t13, which is similar to the period from time t2 to t3, P-phase pixel data (specifically, clock codes corresponding to the reset level) are stored into the P-phase bit storage sections 242P-1 to 242P-N. During a period from time t13 to t14, which is similar to the period from time t3 to t4, the pixel signals stored in the photodiode 121 are transferred to the FD 125.

During a period from time t14 to t15, which is similar to the period from time t4 to t5, D-phase pixel data (specifically, clock codes corresponding to the pixel signal) are stored into the D-phase bit storage sections 242D-1 to 242D-N. In the pixels belonging to the third pixel group PXG3, however, the D-phase bit storage sections 242D-1 to 242D-N are not updated because the third write enable signal WE3 is not in an enable state. Thus, the pixel data stored in the previous frame are retained as they are. Therefore, during the period from time t14 to t15, D-phase pixel data is stored into the D-phase bit storage sections 242D-1 to 242D-N in the pixels belonging to the first pixel group PXG1 and the second pixel group PXG2 only.

During a period from time t15 to t16, the pixel data of the first pixel group PXG1 is transferred to the output section 28. During a period from time t16 to t17, the pixel data of the second pixel group PXG2 is transferred to the output section 28. During a period from time t17 to t20, the pixel data of the third pixel group PXG3 transfer of which has not been done in the previous frame period, is transferred to the output section 28.

Thus, for the third pixel group PXG3 in which transfer of the pixel data from the latch storage sections 72 to the output section 28 is not completed within one frame period, transfer of the pixel data from the latch storage sections 72 to the output section 28 can be resumed in the following frame period in order to prevent update of the latch storage sections 72 in the respective pixels of the third pixel group PXG3 in the following frame period.

Since the third pixel group PXG3 is for imaging, for example, a still picture, it is not necessary to update the pixel data of the third pixel group PXG3 in every frame period. For this reason, any trouble is not caused in practical use even if the latch storage sections 72 storing the pixel data of the third pixel group PXG3 are not updated in every frame.

### <Interpolation of Pixel Data>

Each of the first to third pixel groups PXG1, PXG2, and PXG3 does not necessarily include successive pixel blocks, as depicted in FIGS. 10A and 10B. A pixel that is adjacent to a certain pixel of a certain pixel group may belong to another pixel group. For example, in a case where the pixels belonging to the second pixel group PXG2 are used to detect an image plan phase difference, the spatial resolution of the normal pixel group PXG3 is degraded. For this reason, in a case where a pixel that does not belong to the third pixel group PXG3 exists in the region of the third pixel group PXG3, it is desirable to interpolate this pixel with surrounding pixels that belong to the third pixel group PXG3. This interpolation is performed at the output section 28, for example.

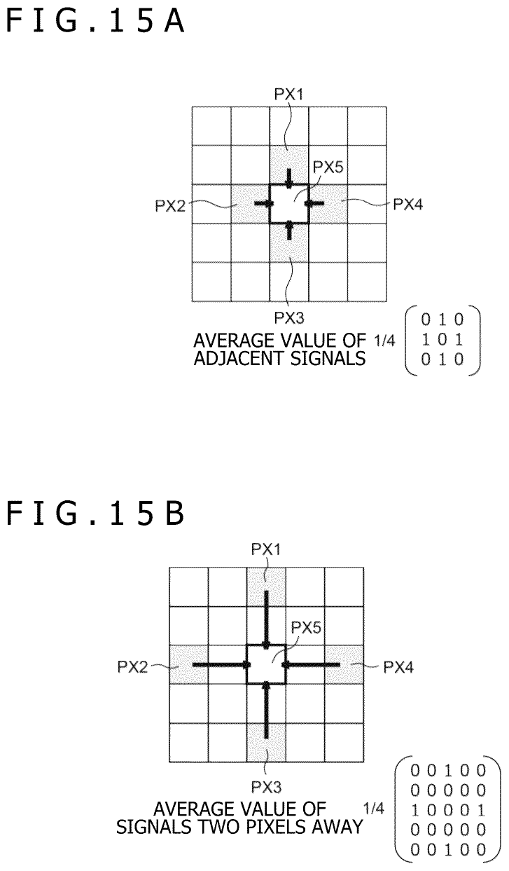

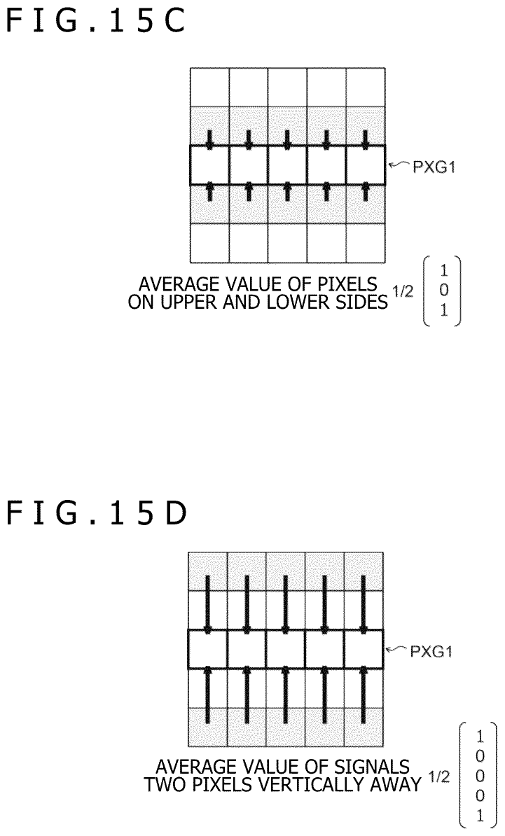

FIGS. 15A, 15B, 15C, and 15D indicate representative specific examples of the interpolation. For example, FIG. 15A depicts a case where a pixel PX5 that is located between four pixels PX1 to PX4 belonging to the third pixel group PXG3 does not belong to the third pixel group PXG3. In this case, an interpolation process of, for example, obtaining an average value of the pixel data of the four pixels PX1 is performed to estimate pixel data of the pixel PX5. A 3×3 matrix in which 1 represents a pixel to be used for the interpolation process is depicted on the upper left part of FIG. 15A. The number of rows and the number of columns in the matrix may be set to four or more, and a smaller interpolation weight (being less than 1) may be applied to a pixel located further away from a pixel to be interpolated, so that the interpolation process can be performed more finely.

To estimate the pixel data by performing the interpolation process, it is desirable to use pixel data of the same color. In a Bayer layout, for example, the color of a pixel that is adjacent to a pixel to be interpolated is not necessarily the same as the color of the pixel to be interpolated. Therefore, as depicted in FIG. 15B, the pixels PX1 to PX4 which are arranged two pixels away horizontally and vertically from the pixel PX5 that is to be interpolated and whose colors are the same as that of the pixel PX5 may be used to perform the interpolation process. The interpolation process in FIG. 15B can be represented by a 5×5 matrix which is depicted in the lower right part of FIG. 15B. In this matrix, 0 may be replaced with a value less than 1, so that the interpolation process can be performed more finely.

FIG. 15C depicts a case where a horizontal pixel row that does not belong to the third pixel group PXG3, for example, is interpolated with the upper and lower pixel rows belonging to the third pixel group PXG3. The pixel data of two pixels above and below a pixel to be interpolated is used to perform the interpolation process. The interpolation process in FIG. 15C can be represented by a 1×3 matrix which is depicted in the lower right part of FIG. 15C. In this matrix, 0 may be replaced with a value less than 1 so that the interpolation process can be performed more finely.

FIG. 15D depicts one modification of FIG. 15C. In a case where the color of pixel rows above and below a pixel row to be interpolated is different from the color of the pixel row to be interpolated, pixel data of pixel rows that are arranged two rows above and below the pixel row to be interpolated may be used to perform interpolation. The interpolation process in FIG. 15D can be represented by a 1×5 matrix, as depicted in the lower right part of FIG. 15D.

FIGS. 15A to 15D each merely indicate one example of the interpolation process. A variety of modifications can be made. The interpolation process can be performed for any one of the first to third pixel groups PXG1, PXG2, and PXG3.

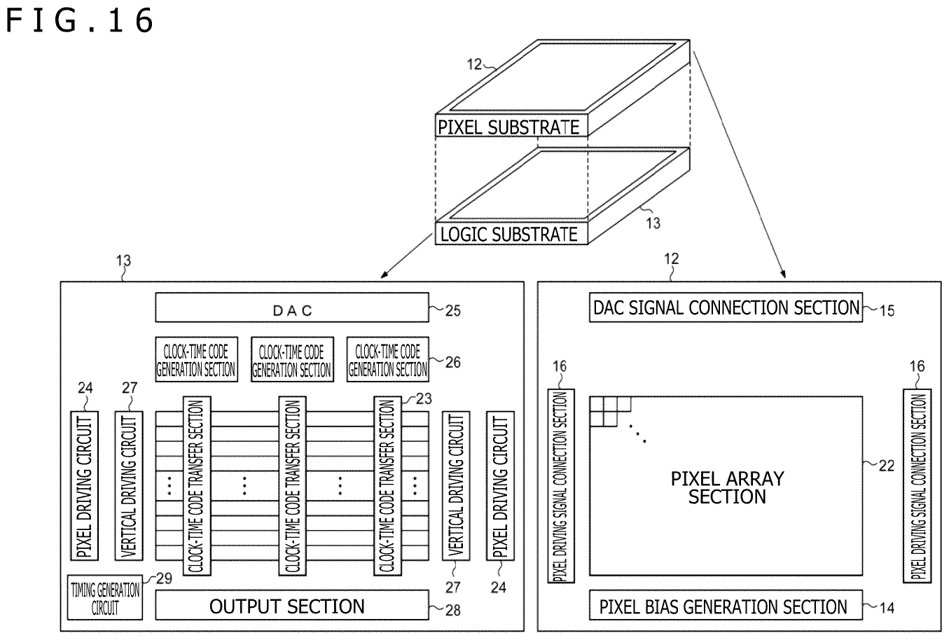

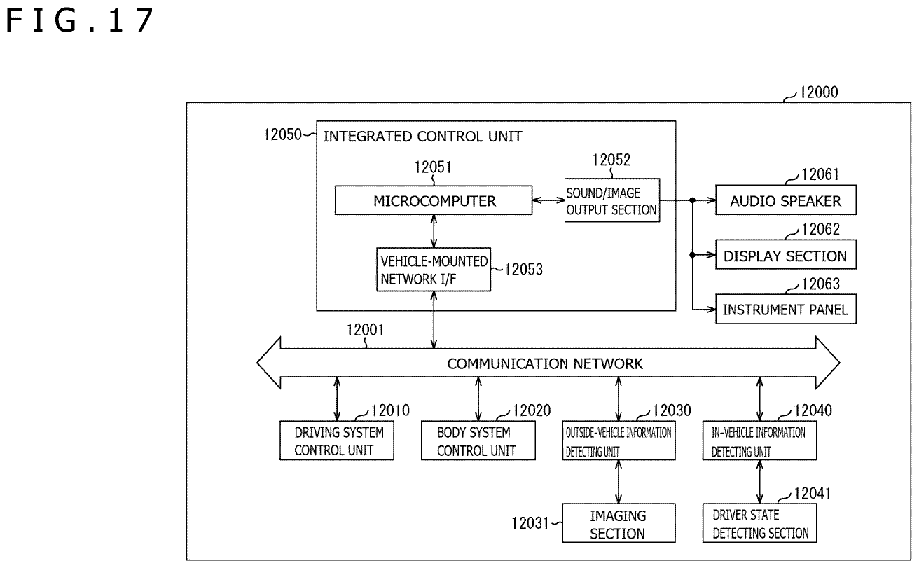

The imaging device 1 according to the present embodiment can be formed by layering two substrates. FIG. 16 is a diagram depicting one example of forming the imaging device 1 by layering a pixel substrate (first substrate) 12 and a logic substrate (second substrate) 13. The pixel substrate 12 is disposed on a light incident surface side. The logic substrate 13 is disposed under the pixel substrate 12. The pixel substrate 12 and the logic substrate 13 are bonded together by Cu—Cu joint, vias, or bumps, for example.

The pixel array section 22, a pixel bias generation section 14, a DAC signal connection section 15, and a pixel driving signal connection section 16 are disposed on the pixel substrate 12. The pixel bias generation section 14 generates a bias voltage to be supplied to the pixels in the pixel array section 22. The DAC signal connection section 15 exchanges signals of various types with the DAC 25 in the logic substrate 13. The pixel driving signal connection sections 16 are disposed on both sides, in the horizontal direction, of the pixel array section 22, and exchange signals of various types for AD conversion with the logic substrate 13.

The pixel driving circuit 24, the DAC (D/A Converter) 25, the clock-time code generation section 26, the vertical driving circuit 27, the output section 28, and the timing generation circuit 29 are formed on the logic substrate 13. FIG. 16 depicts a case where the vertical driving circuits 27 are disposed on both sides, in the horizontal direction, on the logic substrate 13, but the vertical driving circuit 27 may be disposed on only one side, as depicted in FIG. 1.

The pixel bias generation section 14 of the pixel substrate 12 and the output section 28 of the logic substrate 13 exchange signals of various types through Cu—Cu joint or the like. In addition, the DAC signal connection section 15 of the pixel substrate 12 and the DAC 25 of the logic substrate 13 exchange signals of various types by Cu—Cu joint, or the like. Since a reference signal generated by the DAC 25 is supplied to the pixels on the pixel substrate 12, wires for reference signals are arranged into a mesh shape on the pixel substrate 12. In order to shorten the wires, a plurality of vias is disposed in the DAC signal connection section 15, so that a reference signal is supplied to the pixel substrate 12 through the plurality of vias. In addition, the pixel driving signal connection section 16 of the pixel substrate 12 and the pixel driving circuit 24 of the logic substrate 13 exchange signals of various types by Cu—Cu joint, or the like.

The DAC signal connection section 15 of the pixel substrate 12 and the DAC 25 of the logic substrate 13 are positioned so as to overlap each other in the layered direction, but the area of the DAC signal connection section 15 is not necessarily equal to that of the DAC 25. Also, it is sufficient that the pixel bias generation section 14 of the pixel substrate 12 and the output section 28 of the logic substrate 13 at least partially overlap each other in the layered direction, and the area of the pixel bias generation section 14 is not necessarily equal to that of the output section 28. Also, it is sufficient that the pixel driving signal connection section 16 of the pixel substrate 12 and the pixel driving circuit 24 of the logic substrate 13 at least partially overlap each other in the layered direction, and the area of the pixel driving signal connection section 16 is not necessarily equal to that of the pixel driving circuit 24.

For example, the pixel circuit 41 in a frame 60 in FIG. 5 and a portion of the differential input circuit 61 in the comparison circuit 51 are disposed on the pixel substrate 12 while the remaining sections are disposed on the logic substrate 13.

### <Examples of Applications>

The above-mentioned embodiment exemplifies the imaging device 1 in which the pixels in the pixel array section 22 include respective photodiodes. However, in a physical quantity detection circuit according to the present embodiment, it is unnecessary that pixels include respective photodiodes. For example, the respective pixels in the pixel array section 22 may be configured to detect some physical quantities such as the sound pressure of a sound wave and a biological information quantity. Specific examples of the biological information quantity include a blood pressure, a bloodstream, and a pulse rate.

A plurality of pixel groups in the pixel array section 22 may have different pixel characteristics. For example, the pixel characteristic may include a pixel sensitivity and/or a saturation quantity of storable physical quantity signals. Alternatively, the pixel characteristic may include at least one of a phase difference, brightness information, gradation information, color information, event information, environment information, biological information, and sonic information.

In addition, the pixel characteristic may include the resolution of an ADC 42 that is provided for each pixel in at least two pixel groups. For example, the first to third pixel groups PXG1, PXG2, and PXG3 in FIG. 10A or FIG. 10B may be different in the resolution of the ADCs 42 of the respective pixels. The resolution difference makes a difference in the pixel data amount. For example, the resolution of the ADCs 42 of the respective pixels in the third pixel group PXG3 is set to be higher than the resolution of the ADCs 42 in the pixel groups PXG1 and PXG2. If so, even when transfer of the pixel data of the third pixel group PXG3 is not completed within one frame period, transfer of the pixel data can be resumed in the following frame period according to the present embodiment. Accordingly, the resolution of the ADCs 42 can be determined for each pixel group.

In addition, the pixel characteristic may include the storage capacity of the latch storage section 72 in each pixel. For example, the first to third pixel groups PXG1, PXG2, and PXG3 in FIG. 10A or FIG. 10B may be different in the storage capacity of the latch storage sections 72 of the respective pixels. When the resolution of the ADCs 42 is increased, the data amount of the pixel data is increased, as previously explained. In this case, it is necessary to increase the storage capacity of the latch storage sections 72. Moreover, when the exposure time is increased, the data amount of the pixel data is increased. In this case, it is necessary to increase the storage capacity of the latch storage sections 72.

In addition, a plurality of pixel groups in the pixel array section 22 may have different signal detection periods. A signal detection period may include an exposure time and/or a signal reading time. For example, the first to third pixel groups PXG1, PXG2, and PXG3 in the pixel array section 22 in FIG. 10A or FIG. 10B may be different in the exposure time in each pixel, or may be different in the signal reading time in each pixel.

As described so far, in a case where the pixel array section 22 is divided into a plurality of pixel groups and the pixel groups separately perform signal processing in the present embodiment, whether or not to update the latch storage sections 72 storing AD-converted pixel data, can be controlled in each of the pixel groups. Accordingly, in a pixel group in which transfer of pixel data to the output section 28 is not completed within one frame period, update of the latch storage sections 72 is refrained, so that transfer of the pixel data can be resumed in the following frame period. Consequently, while the plurality of pixel groups in the pixel array section 22 can be made different from each other in pixel characteristics, or can be made different from each other in signal detection periods, an output period of pixel data can be optimized in each of the pixel groups.

### <Examples of Applications to Mobile Bodies>

A technology according to the present disclosure (present technology) is applicable to a variety of products. For example, the technology according to the present disclosure may be realized as a device to be installed on a mobile body such as an automobile, an electric automobile, a hybrid electric automobile, a motor cycle, a bicycle, a personal mobility, an airplane, a drone, a ship, or a robot.

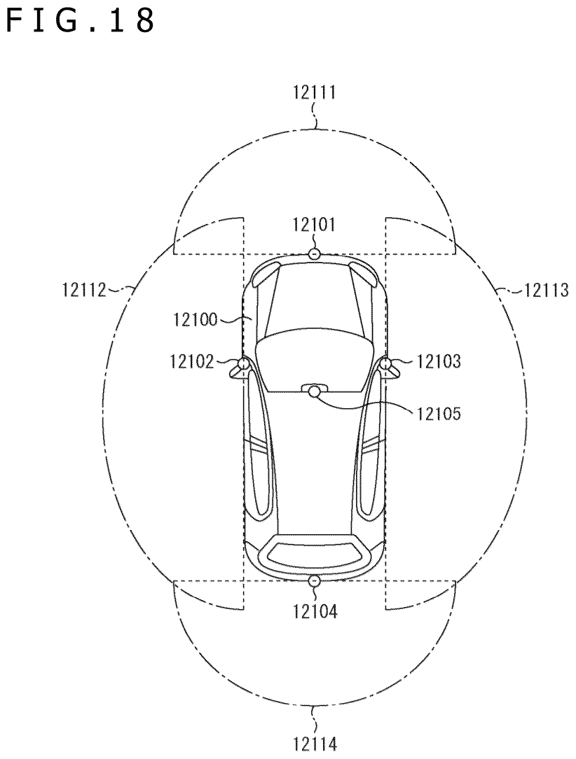

FIG. 18 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 18, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 18, an audio speaker 12061, a display section 12062, and an instrument panel 12063 are illustrated as the output device. The display section 12062 may, for example, include at least one of an on-board display and a head-up display.

FIG. 19 is a diagram depicting an example of the installation position of the imaging section 12031.

In FIG. 19, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 19 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

One example of the vehicle control system to which the technology according to the present disclosure is applicable has been explained. The technology according to the present disclosure is applicable to the imaging section 12031 of the above-mentioned configuration. Specifically, the solid state imaging device 1 according to the present disclosure is applicable to the imaging section 12031. If the technology according to the present disclosure is applied to the imaging section 12031, a clearer image can be captured. This can relieve fatigue of a driver.

Note that the present technology may be implemented in the following configurations.

(1)

A physical quantity detecting device including:
at least two pixel groups that each detect a physical quantity;
a storage section that stores data corresponding to the physical quantity detected by a pixel in each of the pixel groups; and
a storage control section that performs control to cause the storage section to store the data, and further, controls, for each of the pixel groups, whether or not to update the data stored in the storage section.
   (2)

The physical quantity detecting device according to (1), in which
the storage section is an analog memory or a digital memory.
   (3)

The physical quantity detecting device according to (1) or (2), further including:
an AD converter that includes the storage section, and that converts a physical quantity signal detected for each pixel in each of the pixel groups, to a digital signal by comparing the physical quantity signal with a reference signal.
   (4)

The physical quantity detecting device according to (3), further including:
a clock-time code generation section that generates a clock-time code that changes with time; and
a reference signal generation section that generates the reference signal the voltage level of which changes with time, in which
the storage section stores the clock-time code corresponding to a timing at which the clock-time code matches the reference signal.
   (5)

The physical quantity detecting device according to any one of (1) to (4), in which
all pixels in the two pixel groups detect the physical quantities at the same timing every prescribed period, and
for a pixel group, of the at least two pixel groups, in which output of data in the storage section of each pixel in the pixel group is not completed in the prescribed period, the storage control section retains the data stored in the storage section in a following prescribed period without updating the data.
   (6)

The physical quantity detecting device according to (5), in which
the prescribed period is a cycle of a vertical synchronization signal.
   (7)

The physical quantity detecting device according to any one of (1) to (6), in which
the at least two pixel groups have different pixel characteristics.
   (8)

The physical quantity detecting device according to (7), in which
the pixel characteristic includes a pixel sensitivity and/or a saturation quantity of storable physical quantity signals.
   (9)

The physical quantity detecting device according to (7), in which
the pixel characteristic includes at least one of a phase difference, brightness information, gradation information, color information, event information, environment information, biological information, and sonic information.
   (10)

The physical quantity detecting device according to (7), in which
the pixel characteristic includes a resolution of an AD converter that is provided for each pixel in the at least two pixel groups.
   (11)

The physical quantity detecting device according to (7), in which
the pixel characteristic includes a storage capacity of the storage section.
   (12)

The physical quantity detecting device according to any one of (1) to (11), in which
the at least two pixel groups have different signal detection periods.
   (13)

The physical quantity detecting device according to (12), in which
the signal detection period includes an exposure time and/or a signal reading time.
   (14)

The physical quantity detecting device according to any one of (1) to (13), further including:
an interpolation processing section that interpolates a physical quantity of a pixel that is not included in the pixel group, with a physical quantity of a pixel that is located therearound and belongs to the pixel group.
   (15)

The physical quantity detecting device according to any one of (1) to (14), further including:
a pixel array section including a plurality of pixels that is divided into the at least two pixel groups;
a plurality of control wires that controls reading of all pixels in the pixel array section; and
a contact that connects each pixel in the pixel array section to the corresponding control wire according to which pixel group the pixel belongs to.
   (16)

The physical quantity detecting device according to (15), in which
the plurality of control wires is arranged in regions of all pixels in the pixel array section, and
each pixel in the pixel array section is connected to any one of the control wires via the contact.
   (17)

The physical quantity detecting device according to any one of (1) to (16), in which
the physical quantity includes at least one of a light intensity, a sound pressure of a sound wave, and a biological information amount.
   (18)

The physical quantity detecting device according to any one of (1) to (17), in which
the physical quantity includes a light intensity, and
the at least two pixel groups include at least one of a region for capturing a still picture image, a region for capturing a video, and a region for detecting an image plane phase difference.
   (19)

An imaging device including:
a pixel array section that includes a plurality of pixels that is divided into at least two pixel groups;
an AD converter that is disposed in each of the pixels and performs analog-digital conversion of a pixel signal;
a clock-time code generation section that generates a clock-time code that changes with time;
a reference signal generation section that generates a reference signal a voltage level of which changes with time;
a signal processing section that performs signal processing on pixel data outputted from the AD converter of each of the pixels,
the AD converter including
   a storage section that stores the clock-time code corresponding to the pixel signal by comparing the pixel signal with the reference signal; and
a storage control section that performs control to cause the storage section to store the clock-time code, and controls, for each of the pixel groups, whether or not to update the clock-time code stored in the storage section.
   (20)

The imaging device according to (19), in which,
for a pixel group in which output of data of all pixels is not completed in a vertical synchronization period, the storage control section retains the clock-time code stored in the corresponding storage section in a following vertical synchronization period without updating the stored clock-time code.

Embodiments according to the present disclosure are not limited to the above-mentioned embodiments, but include a variety of modifications that a person skilled in the art could conceive of. Further, effects of the present disclosure are not limited to the above-mentioned ones. That is, a variety of additions and modifications and partial removal can be made within the conceptual principles and gist of the present disclosure which are derived from the features specified by the claims and equivalents thereof.

### REFERENCE SIGNS LIST

1: Imaging device
11: Semiconductor substrate
12: Pixel substrate
13: Logic substrate
14: Pixel bias generation section
15: DAC signal connection section
16: Pixel driving signal connection section
20: Cluster
21: Pixel
22: Pixel array section
23: Clock-time code transfer section
24: Pixel driving circuit
26: Clock-time code generation section
27: Vertical driving circuit
28: Output section
29: Timing generation circuit
41: Pixel circuit
42: AD converter
51: Comparison circuit
52: Data storage section
60: Frame
61: Differential input circuit
62: Voltage conversion circuit
63: Positive feedback circuit
71: Latch control circuit
72: Latch storage section
121: Photodiode
122: Discharge transistor
123: Transfer transistor
124: Reset transistor
202P-N: P-phase bit storage section
241D: D-phase latch control section
241D: Latch control section
241P: P-phase latch control section
241P: Latch control section
242: Bit storage section
242D-1: D-phase bit storage section
242D-N: D-phase bit storage section
242P: P-phase bit storage section
242P-1: P-phase bit storage section
242P-N: P-phase bit storage section
243: Switch
244: Latch circuit
245: Transistor
246: Capacitor
247: Second transistor
248: Transistor
249: NAND gate
250: Bus
281: Inverter
282: Inverter
283: NOR circuit
284: Inverter
341: Shift register
341-1: Shift register
341-N: Shift register
342: Clock supply circuit
371: Bidirectional buffer circuit
371-1: Bidirectional buffer circuit
371-N: Bidirectional buffer circuit
381: Buffer circuit
382: Inverter circuit
561D: AND circuit
561P: AND circuit

1. A physical quantity detecting device comprising:
at least two pixel groups that each detect a physical quantity;
a storage section that stores data corresponding to the physical quantity detected by a pixel in each of the pixel groups; and
a storage control section that performs control to cause the storage section to store the data, and further, controls, for each of the pixel groups, whether or not to update the data stored in the storage section.

2. The physical quantity detecting device according to claim 1, wherein
the storage section is an analog memory or a digital memory.

3. The physical quantity detecting device according to claim 1, further comprising:
an AD converter that includes the storage section, and that converts a physical quantity signal detected for each pixel in each of the pixel groups, to a digital signal by comparing the physical quantity signal with a reference signal.

4. The physical quantity detecting device according to claim 3, further comprising:
a clock-time code generation section that generates a clock-time code that changes with time; and
a reference signal generation section that generates the reference signal the voltage level of which changes with time, wherein
the storage section stores the clock-time code corresponding to a timing at which the clock-time code matches the reference signal.

5. The physical quantity detecting device according to claim 1, wherein
all pixels in the two pixel groups detect the physical quantities at the same timing every prescribed period, and
for a pixel group, of the at least two pixel groups, in which output of data in the storage section of each pixel in the pixel group is not completed in the prescribed period, the storage control section retains the data stored in the storage section in a following prescribed period without updating the data.

6. The physical quantity detecting device according to claim 5, wherein
the prescribed period is a cycle of a vertical synchronization signal.

7. The physical quantity detecting device according to claim 1, wherein
the at least two pixel groups have different pixel characteristics.

8. The physical quantity detecting device according to claim 7, wherein
the pixel characteristic includes a pixel sensitivity and/or a saturation quantity of storable physical quantity signals.

9. The physical quantity detecting device according to claim 7, wherein
the pixel characteristic includes at least one of a phase difference, brightness information, gradation information, color information, event information, environment information, biological information, and sonic information.

10. The physical quantity detecting device according to claim 7, wherein
the pixel characteristic includes a resolution of an AD converter that is provided for each pixel in the at least two pixel groups.

11. The physical quantity detecting device according to claim 7, wherein
the pixel characteristic includes a storage capacity of the storage section.

12. The physical quantity detecting device according to claim 1, wherein
the at least two pixel groups have different signal detection periods.

13. The physical quantity detecting device according to claim 12, wherein
the signal detection period includes an exposure time and/or a signal reading time.

14. The physical quantity detecting device according to claim 1, further comprising:
an interpolation processing section that interpolates a physical quantity of a pixel that is not included in the pixel group, with a physical quantity of a pixel that is located therearound and belongs to the pixel group.

15. The physical quantity detecting device according to claim 1, further comprising:
a pixel array section including a plurality of pixels that is divided into the at least two pixel groups;
a plurality of control wires that controls reading of all pixels in the pixel array section; and
a contact that connects each pixel in the pixel array section to the corresponding control wire according to which pixel group the pixel belongs to.

16. The physical quantity detecting device according to claim 15, wherein
the plurality of control wires is arranged in regions of all pixels in the pixel array section, and
each pixel in the pixel array section is connected to any one of the control wires via the contact.

17. The physical quantity detecting device according to claim 1, wherein
the physical quantity includes at least one of a light intensity, a sound pressure of a sound wave, and a biological information amount.

18. The physical quantity detecting device according to claim 1, wherein
the physical quantity includes a light intensity, and
the at least two pixel groups include at least one of a region for capturing a still picture image, a region for capturing a video, and a region for detecting an image plane phase difference.

19. An imaging device comprising:
a pixel array section that includes a plurality of pixels that is divided into at least two pixel groups;
an AD converter that is disposed in each of the pixels and performs analog-digital conversion of a pixel signal;
a clock-time code generation section that generates a clock-time code that changes with time;
a reference signal generation section that generates a reference signal a voltage level of which changes with time;
a signal processing section that performs signal processing on pixel data outputted from the AD converter of each of the pixels,
the AD converter including
a storage section that stores the clock-time code corresponding to the pixel signal by comparing the pixel signal with the reference signal; and
a storage control section that performs control to cause the storage section to store the clock-time code, and controls, for each of the pixel groups, whether or not to update the clock-time code stored in the storage section.

20. The imaging device according to claim 19, wherein,
for a pixel group in which output of data of all pixels is not completed in a vertical synchronization period, the storage control section retains the clock-time code stored in the corresponding storage section in a following vertical synchronization period without updating the stored clock-time code.
